(19) United States
(12) Patent Application Publication
(10) Pub. No.: US 2025/0371634 A1
(43) Pub. Date: Dec. 4, 2025

(54) SYSTEM AND METHOD FOR NEAR-INSTANT TRADEMARK APPROVAL AND REJECTION VIA AI-POWERED LEGAL REASONING

(71) Applicant: Raj Abhyanker, Cupertino, CA (US)

(72) Inventor: Raj Abhyanker, Cupertino, CA (US)

(21) Appl. No.: 19/296,951

(22) Filed: Aug. 12, 2025

Related U.S. Application Data
(63) Continuation-in-part of application No. 18/199,908, filed on May 19, 2023, now Pat. No. 12,406,144.

(51) Int. Cl. G06Q 50/18; G06F 40/279; G06F 40/30; G06F 40/40; G06Q 10/0635; G06V 10/70; G06V 10/764; G06V 20/00

(52) U.S. Cl. CPC G06Q 50/184; G06F 40/279; G06F 40/30; G06F 40/40; G06Q 10/0635; G06V 10/764; G06V 10/768; G06V 20/95; G06V 2201/10

(57) ABSTRACT

Disclosed is a system and/or a method for near-instant trademark approval and rejection via ai-powered legal reasoning. The platform includes a user-facing interface enabling an applicant to input a proposed trademark comprising a word mark, logo, and slogan with a textual description of associated goods and services, and optionally visual proof of use in commerce. A classification engine powered by a natural language processing model assists in selecting classes of goods and services from standardized taxonomies. A backend examination engine performs real-time searches, analyses across databases of registered, pending, common law marks using a large language model, and design recognition algorithm. An autonomous legal reasoning module powered by the large language model interprets trademark law precedents, disclaimer requirements, registration criteria, and simulating multi-perspective legal analysis. An outcome generation engine delivers within a predefined time frame a preliminary approval with automated registration, preliminary refusal with detailed explanation, and recommended amendments.

### CLAIM OF PRIORITY

This Application is a Continuation-In-Part Application of, and claims priority to, and incorporates by reference herein the entirety of the disclosure of co-pending U.S. patent application Ser. No. 18/199,908 titled-LINGUISTIC ANALYSIS TO AUTOMATICALLY GENERATE A HYPOTHETICAL LIKELIHOOD OF CONFUSION OFFICE ACTION USING DUPONT FACTORS filed on May 19, 2023.

### FIELD OF TECHNOLOGY

This disclosure relates generally to computer-implemented systems and methods for intellectual property management, and more specifically, to automated systems for evaluating, classifying, and registering trademarks. The invention is situated at the intersection of artificial intelligence (AI), natural language processing (NLP), computer vision, and legal informatics, and provides a platform for automating trademark search, examination, conflict detection, specimen verification, and registration workflows. The invention further pertains to the application of large language models (LLMs) and machine learning algorithms to simulate legal reasoning, generate registration outcomes, and facilitate dispute resolution in the context of national and international trademark law.

### BACKGROUND

The United States Patent and Trademark Office (“USPTO”) wields an unreasonable tax on American innovation and small businesses who seek to protect their trademarks. In 2025, while an entrepreneur can incorporate their business for less than $100 in many states, to seek trademark protection costs $350 per classification. Moreover, while an American entrepreneur can often get their business up and running in just weeks, it takes over a year to register a federal trademark. The combined expense and waiting time creates an unreasonable hindrance to American innovation.

The impact of this hindrance is especially profound on American small business owners and first time entrepreneurs. Businesses must wait over a year before knowing whether the goodwill they are building in their business with their hard work is wasted. Worse yet, if a trademark does not register, small businesses are forced to rebrand products, retail signage, and Amazon®, Instagram®, and Walmart® storefront names. Despite advances in artificial intelligence and cloud computing, the USPTO's core trademark review processes remain largely manual and rule-bound. Trademark examining attorneys must review word marks, logos, and slogans against an ever-growing registry of millions of marks, often relying on outdated databases and text-based search systems. Even when refusals are routine, such as for minor disclaimers or improper classifications, weeks or months are lost in correspondence and clarification, imposing avoidable delays and costs on applicants.

Today's small businesses operate in a fast-paced, digital-first economy. Brand decisions are made in hours, not months. Yet trademark registration operates on a timeline from another era. As competitors and counterfeiters move quickly in global marketplaces, U.S. entrepreneurs are left vulnerable-unable to quickly secure or enforce their rights. The inefficiency is not just a bureaucratic inconvenience; it is a structural disadvantage for American businesses in the digital age.

In addition to high filing fees and long delays, entrepreneurs face another steep barrier: the cost of hiring a trademark attorney. While legal counsel can help navigate refusals, classifications, disclaimers, and office actions, most small businesses cannot afford the thousands of dollars in legal fees often required for a single trademark registration. The average cost of hiring a trademark attorney for basic filing and prosecution can exceed $1,500—and that does not include appeals or responses to complex refusals. As a result, many business owners are forced to file pro se, increasing the likelihood of errors, rejections, and delays. The cost of legal representation turns trademark protection, meant to be a tool for all, into a privilege for the well-capitalized. The very system that was designed to promote fair competition now disproportionately favors those with access to expensive legal support.

A modern solution is needed-one that mirrors the speed and intelligence with which businesses themselves now operate. Entrepreneurs deserve a system that helps them quickly identify potential risks, receive clear answers about registrability, and secure their rights without unnecessary legal friction. Only then can the promise of trademark law-to encourage and protect commerce through brand identity-truly serve the needs of 21st-century American enterprise.

### SUMMARY

Disclosed are a system and/or a method for near-instant trademark approval and rejection via ai-powered legal reasoning.

In one aspect, the computer-implemented platform is for automating evaluation and registration of a trademark. The platform is a user-facing interface that enables an applicant to input a proposed trademark. The proposed trademark is a word mark, logo, or slogan with a textual description of associated goods and services and optionally visual proof of use in commerce. The platform is a classification engine powered by a natural language processing model to assist in selecting classes of goods and services from standardized taxonomies. The platform is a backend examination engine to perform real-time searches and analyses across databases of registered, pending, and/or common law marks using a large language model and a design recognition algorithm. The platform is an autonomous legal reasoning module powered by the large language model to interpret trademark law precedents, disclaimer requirements, and/or registration criteria and to simulate multi-perspective legal analysis through an internal adversarial process. The platform is an outcome generation engine to deliver within a predefined time frame a preliminary approval with automated registration or a preliminary refusal with detailed explanation and recommended amendments.

The computer-implemented platform may include an optional escalation module to enable a human review for applications exhibiting novel, ambiguous, and/or potentially contested legal characteristics. The short predefined time frame may be under 30 minutes and/or ideally under 60 seconds. The computer-implemented platform may include a computer vision and a machine learning subsystem for authenticating submitted trademark specimens. The subsystem may include an image processing engine to receive, parse, and/or inspect photographic and graphical evidence submitted with a trademark filing. The subsystem may include a manipulation detection algorithm trained to identify artifacts of digital alteration including layering, lassoing, pixel duplication, and/or AI-generated text and graphics indicative of forgery. The subsystem may include an intent inference model to evaluate contextual metadata and semantic alignment between the specimen and the goods and services claimed. The subsystem may include an automated classification output to flag suspicious filings for review, provide automated rejection with explanation, and/or clear authentic submissions for continued processing.

Upon preliminary refusal, the platform may automatically generate a structured, editable response for reconsideration and appeal. The response may cite legal justifications, alternative classifications, and/or recommended disclaimers to improve registrability likelihood. The backend examination engine may continually refine examination and adjudication capabilities by ingesting new trademark registrations, TTAB decisions, and/or federal court rulings. The backend examination engine may periodically retrain using active learning loops, feedback from a human examiner, and/or aggregated user behavior data to enhance future decision quality.

The platform may include a fee determination engine to reduce filing costs based on system automation level, applicant profile, and/or filing simplicity, thereby lowering the economic barrier to entry for entrepreneurs with lesser economic means. The platform may include a real-time analytics and transparency module to publish key performance indicators including registration processing time, approval and refusal rate, regional applicant trends, and/or bias audit in a dashboard. The dashboard may be publicly accessible and designed to foster government accountability and public trust.

The platform may include a fully automated dispute resolution system for trademark conflicts. The system may include an online portal in which two or more parties upload potentially conflicting trademarks with claims of ownership, evidence of first use in commerce within the United States, allegations and defenses to trademark infringement, and/or declarations in support and opposition. The system may include an adjudicative reasoning engine to use pre-trained legal inference models to assess likelihood of confusion, prior use, and/or classification conflicts based on statutory law and judicial precedent. The system may include a decision generation component to produce written findings of fact, legal reasoning, and/or determinations on whether confusion and infringement is likely. The system may provide optional pathways for supplemental alternative dispute resolution and a litigation pathway in which one party is unsatisfied with the written findings.

The platform may include a scoring engine to weight semantic and visual conflicts based on the DuPont factors and to output a composite risk score. The platform may include a user interface to visually display the composite risk score with contributing factors and suggestions to reduce risk.

The platform may include a foreign language processing model trained in all human languages to analyze foreign-language trademarks and identify transliterated and translated similarities causing confusion. The platform may include a fraud detection module configured to analyze patterns of repeated submissions, altered specimens, and/or conflicting claims across user accounts to flag potential bad-faith filings. The platform may include an immutable audit logging subsystem to store timestamped records of AI-generated decisions, user actions, and/or revision history to enable traceability and regulatory compliance.

In another aspect, the method includes receiving user input, user input includes a proposed trademark, a textual description of goods and services, and/or a proof of use. The method includes classifying the goods and services via a natural language processing (NLP)-assisted interface. The method includes performing real-time similarity and conflict checks against a database of registered, pending, and/or common law trademarks using a natural language processing (NLP) model and an image recognition model. The method includes autonomously generating a registration decision within minutes based on precedential trademark law analysis. The method includes providing rationale and suggestions in the case of preliminary refusal. The method includes allowing appeals to be reviewed by a human examiner for edge cases.

The platform includes presenting conflicting mark data to an AI model. The platform includes autonomously evaluating confusion, prior use, and/or class overlap based on learned precedent. The platform includes issuing a binding and/or advisory decision. The platform includes offering a streamlined human-appealable path when specific statutory criteria may be met. The platform includes analyzing specimen images for signs of digital manipulation using pixel pattern analysis and forgery detection models through a computer vision module. The platform may cross-reference time, metadata, and/or commerce signals to validate authenticity. The platform may flag potentially fraudulent filings for manual review and automatic rejection. The platform includes continuously updating the natural language processing model and the image recognition model for decision-making criteria based on an outcome from court, TTAB ruling, and/or public feedback to improve performance and fairness. The platform includes, in case of refusal, generating an editable template argument for reconsideration to cite relevant precedents and propose modifications including disclaimer and class narrowing. The platform includes publishing performance metrics, including approval and refusal rates, time-to-registration, and/or audit results in real-time to ensure public trust and institutional transparency.

In yet another aspect, a method of generating a trademark registration includes associating a first keyword formed with an alphanumeric string of characters in a first written script with a semantic meaning based on secondary data. The secondary data includes an image allegedly of a photograph of the first keyword affixed on an article of manufacture of an applicant for the trademark registration, and a contextual credibility of the image as a true and correct representation of the photograph. The secondary data includes a textual description of goods and services on which the first keyword is represented as goods and services on which the first keyword is desired to be affixed. The secondary data includes a web page represented as marketing goods and services associated with the first keyword and a contextual relevancy of the web page as actually marketing the goods and services. The method includes using an artificial intelligence model to generate a trademark registration number for the first keyword associated with the semantic meaning when there is insufficient basis to conclude a confusingly similar trademark in a trademark registry based on any of the DuPont factors. The first keyword is unlikely to dilute a famous trademark. The method includes using the artificial intelligence model to reject the first keyword associated with the semantic meaning from trademark registration when the artificial intelligence model determines a confusingly similar trademark in the trademark registry based on the DuPont factors. The first keyword with the semantic meaning to dilute the famous trademark.

The method further includes rejecting the first keyword associated with the semantic meaning from the trademark registration. The method includes applying the artificial intelligence model to compare the semantic meaning of the first keyword with the semantic meanings of reference marks in a trusted authority database using the DuPont factors. The method includes selecting a confusingly similar mark from the reference marks as likely to be confused with the first keyword based on the DuPont factors. The backend examination engine may continually refine examination and adjudication capabilities by ingesting new trademark registrations, TTAB decisions, and federal court rulings. The backend examination engine may periodically retrain using active learning loops, feedback from a human examiner, and/or aggregated user behavior data to enhance future decision quality.

The method further includes a computer vision and a machine learning subsystem to authenticate submitted trademark specimens. The machine learning subsystem includes an image processing engine to receive, parse, and/or inspect photographic and graphical evidence submitted with trademark filings. The machine learning subsystem includes a manipulation detection algorithm trained to identify artifacts of digital alteration comprising layering, lassoing, pixel duplication, and/or AI-generated text and graphics indicative of forgery. The machine learning subsystem includes an intent inference model to evaluate contextual metadata and semantic alignment between the specimen and the goods and services claimed. The machine learning subsystem includes an automated classification output to flag suspicious filings for review, provide automated rejection with explanation, and/or clear authentic submissions for continued processing.

The method further includes automatically drafting a proposed argument in issue, rule, application, and/or conclusion format to support a position on rejection of the first keyword with a confusingly similar trademark in the trademark registry based on the DuPont factors and dilution of a famous trademark.

The methods and systems disclosed herein may be implemented in any means for achieving various aspects, and may be executed in various forms, when executed by a machine, cause the machine to perform any of the operations disclosed herein. Other features will be apparent from the accompanying drawings and from the detailed description that follows.

### BRIEF DESCRIPTION OF THE DRAWINGS

The embodiments of this invention are illustrated by way of example and not limitation in the figures of the accompanying drawings, in which like references indicate similar elements and in which:

FIG. 1 is a network view illustrating a linguistic analysis server to associate a first written script with a documented string of characters of a trusted authority based on semantic analysis to generate a response to support a position on the similarity between the semantic inference of the first keyword with a second keyword, according to one embodiment.

FIG. 2 is a block diagram illustrating a semantic analysis module and an inference module of the linguistic analysis server of FIG. 1, according to one embodiment.

FIG. 3 is a flow diagram of the linguistic analysis server of FIG. 1 illustrating the semantic analysis layers of the system, according to one embodiment.

FIG. 4 is a graphical flow diagram of the linguistic analysis server of FIG. 1 illustrating steps of the linguistic analysis server to associate a first written script with a documented string of characters of a trusted authority based on semantic analysis to generate a response to support a position on the similarity between the semantic inference of the first keyword with a second keyword, according to one embodiment.

FIG. 5 is a user interface view of a computer-implemented platform for automating evaluation and registration of a trademark using the linguistic analysis server of FIG. 1, according to one embodiment.

FIG. 6 is a user interface view illustrating a refusal page and a rationale page of the computer-implemented platform for automating evaluation and registration of the trademark using the linguistic analysis server of FIG. 1, according to one embodiment.

FIG. 7 is a network view of the linguistic analysis server of FIG. 1 illustrating the computer-implemented platform for automating evaluation and registration of a trademark providing a legal reasoning for trademark approval and/or rejection via a computing device communicatively coupled to the linguistic analysis server, according to one embodiment.

FIG. 8 is a schematic view of the linguistic analysis server of FIG. 1 illustrating a machine learning subsystem for authenticating trademark specimens, according to one embodiment.

FIG. 9 is a block diagram of the linguistic analysis server of FIG. 1 illustrating automated trademark conflict resolution system with an online dispute portal, according to one embodiment.

FIG. 10 is a block diagram of the linguistic analysis server of FIG. 1 illustrating a fee determination engine, a real-time analytics and a transparency module to calculate filing fees and to publish key performance indicators with processing time, approval and refusal rates, according to one embodiment.

FIG. 11 is a block diagram of the linguistic analysis server of FIG. 1 illustrating a scoring engine and virtual risk UI to display contributing factors and suggestions via the user interface, according to one embodiment.

FIG. 12 is a flowchart view of the linguistic analysis server of FIG. 1 illustrating a semantic meaning engine and registration decision process, according to one embodiment.

FIG. 13 is a process flow diagram of the linguistic analysis server of FIG. 1 illustrating a multilingual foreign-language processing model to analyze trademarks in all human languages, according to one embodiment.

FIG. 14 is a process flow diagram of the linguistic analysis server of FIG. 1 illustrating a fraud detection module to analyze patterns of repeated submissions, according to one embodiment.

FIG. 15 is a process flow diagram of the linguistic analysis server of FIG. 1 illustrating an immutable audit logging subsystem in trademark evaluation processes, according to one embodiment.

FIG. 16 is a process flow diagram of the linguistic analysis server of FIG. 1 illustrating a continuous model refinement loop to enhance decision quality over time, according to one embodiment.

Other features of the present embodiments will be apparent from the accompanying drawings and from the detailed description that follows.

### DETAILED DESCRIPTION

Example embodiments, as described below, may be used to provide a system and/or a method for near-instant trademark approval and rejection via ai-powered legal reasoning.

In one embodiment, the computer-implemented platform is for automating evaluation and registration of a trademark. The platform is a user-facing interface 504 that enables an applicant 502 to input a proposed trademark 408. The proposed trademark is a word mark, logo, or slogan with a textual description 702 of associated goods and services and optionally visual proof of use in commerce 308. The platform is a classification engine 704 powered by a natural language processing model 716 to assist in selecting classes of goods and services from standardized taxonomies. The platform is a backend examination engine 706 to perform real-time searches and analyses across databases of registered, pending, and/or common law marks using a large language model 718 and a design recognition algorithm 708. The platform is an autonomous legal reasoning module 710 powered by the large language model 718 to interpret trademark law precedents, disclaimer requirements, and/or registration criteria and to simulate multi-perspective legal analysis through an internal adversarial process. The platform is an outcome generation engine 712 to deliver within a predefined time frame a preliminary approval with automated registration 1206 or a preliminary refusal with detailed explanation and recommended amendments 1208.

The computer-implemented platform may include an optional escalation module 714 to enable a human review for applications exhibiting novel, ambiguous, and/or potentially contested legal characteristics. The short predefined time frame may be under 30 minutes and/or ideally under 60 seconds. The computer-implemented platform may include a computer vision 802 and a machine learning subsystem 804 for authenticating submitted trademark specimens. The subsystem may include an image processing engine 806 to receive, parse, and/or inspect photographic and graphical evidence submitted with a trademark filing. The subsystem may include a manipulation detection algorithm 808 trained to identify artifacts of digital alteration including layering, lassoing, pixel duplication, and/or AI-generated text and graphics indicative of forgery. The subsystem may include an intent inference model 810 to evaluate contextual metadata and semantic alignment between the specimen and the goods and services claimed. The subsystem may include an automated classification output 812 to flag suspicious filings for review, provide automated rejection with explanation, and/or clear authentic submissions for continued processing.

Upon preliminary refusal, the platform may automatically generate a structured, editable response for reconsideration and appeal 1208. The response may cite legal justifications, alternative classifications 704, and/or recommended disclaimers to improve registrability likelihood. The backend examination engine 706 may continually refine examination and adjudication capabilities by ingesting new trademark registrations, TTAB decisions, and/or federal court rulings stored within the trusted authority database 132. The backend examination engine 706 may periodically retrain using active learning loops, feedback from a human examiner via the optional escalation module 714, and/or aggregated user behavior data to enhance future decision quality.

The platform may include a fee determination engine 1002 to reduce filing costs based on system automation level, applicant profile 502, and/or filing simplicity, thereby lowering the economic barrier to entry for entrepreneurs with lesser economic means. The platform may include a real-time analytics 1004 and transparency module 1006 to publish key performance indicators including registration processing time, approval and refusal rate, regional applicant trends, and/or bias audit in a dashboard rendered on the user interface 504. The dashboard may be publicly accessible and designed to foster government accountability and public trust.

The platform may include a fully automated dispute resolution system for trademark conflicts. The system may include an online portal 902 in which two or more parties upload potentially conflicting trademarks 408 with claims of ownership, evidence of first use in commerce within the United States 308, allegations and defenses to trademark infringement, and/or declarations in support and opposition. The system may include an adjudicative reasoning engine 904 to use pre-trained legal inference models 718 to assess likelihood of confusion, prior use, and/or classification conflicts based on statutory law and judicial precedent stored in the trusted authority database 132. The system may include a decision generation component 906 to produce written findings of fact, legal reasoning, and/or determinations on whether confusion and infringement is likely. The system may provide optional pathways for supplemental alternative dispute resolution 908 and a litigation pathway 910 in which one party is unsatisfied with the written findings.

The platform may include a scoring engine 1102 to weight semantic and visual conflicts based on the DuPont factors contained in the set of comparative rules 138 and to output a composite risk score visualized on a composite risk display 1112. The platform may include a user interface 504 to visually display the composite risk score with contributing factors and suggestions to reduce risk.

The platform may include a foreign language processing model 1106 trained in all human languages to analyze foreign-language trademarks 408 and identify transliterated and translated similarities causing confusion. The platform may include a fraud detection module 1108 configured to analyze patterns of repeated submissions, altered specimens 308, and/or conflicting claims across user accounts to flag potential bad-faith filings. The platform may include an immutable audit logging subsystem 1110 to store timestamped records of AI-generated decisions 1204, user actions on the user interface 504, and/or revision history to enable traceability and regulatory compliance.

In another embodiment, the method includes receiving user input, user input includes a proposed trademark 408, a textual description of goods and services 702, and/or a proof of use 308. The method includes classifying the goods and services via a natural language processing NLP-assisted interface 716 operating within the classification engine 704. The method includes performing real-time similarity and conflict checks against a database of registered, pending, and/or common law trademarks using a natural language processing NLP model 716 and an image recognition model implemented as the design recognition algorithm 708 with computer vision 802. The method includes autonomously generating a registration decision 1204 within minutes based on precedential trademark law analysis compiled by the legal reasoning module 710. The method includes providing rationale and suggestions in the case of preliminary refusal as a proposed legal argument 1208. The method includes allowing appeals to be reviewed by a human examiner for edge cases via the optional escalation module 714.

The platform includes presenting conflicting mark data to an AI model 718. The platform includes autonomously evaluating confusion, prior use, and/or class overlap based on learned precedent referenced from the trusted authority database 132. The platform includes issuing a binding and/or advisory decision 906. The platform includes offering a streamlined human-appealable path when specific statutory criteria may be met 714. The platform includes analyzing specimen images for signs of digital manipulation using pixel pattern analysis and forgery detection models through a computer vision module 802. The platform may cross-reference time, metadata, and/or commerce signals to validate authenticity within the machine learning subsystem 804. The platform may flag potentially fraudulent filings for manual review and automatic rejection via the automated classification output 812. The platform includes continuously updating the natural language processing model 716 and the image recognition model 708 for decision-making criteria based on an outcome from court, TTAB ruling, and/or public feedback to improve performance and fairness. The platform includes, in case of refusal, generating an editable template argument 1208 for reconsideration to cite relevant precedents and propose modifications including disclaimer and class narrowing. The platform includes publishing performance metrics, including approval and refusal rates, time-to-registration, and/or audit results in real-time to ensure public trust and institutional transparency via real-time analytics 1004 and the transparency module 1006.

In yet another embodiment, a method of generating a trademark registration includes associating a first keyword 408 formed with an alphanumeric string of characters 410 in a first written script 404 with a semantic meaning represented by semantic inference 418 based on secondary data. The secondary data includes an image allegedly of a photograph 406 of the first keyword 408 affixed on an article of manufacture 402 of an applicant 502 for the trademark registration 1206, and a contextual credibility of the image 406 as a true and correct representation of the photograph. The secondary data includes a textual description of goods and services 702 on which the first keyword 408 is represented as goods and services on which the first keyword 408 is desired to be affixed. The secondary data includes a web page 405 represented as marketing goods and services associated with the first keyword 408 and a contextual relevancy of the web page 405 as actually marketing the goods and services. The method includes using an artificial intelligence model implemented as the registration decision AI 1204 to generate a trademark registration number 1206 for the first keyword 408 associated with the semantic meaning 418 when there is insufficient basis to conclude a confusingly similar trademark in a trademark registry maintained in the trusted authority database 132 based on any of the DuPont factors in the set of comparative rules 138. The first keyword 408 is unlikely to dilute a famous trademark. The method includes using the artificial intelligence model 1204 to reject the first keyword 408 associated with the semantic meaning 418 from trademark registration 1206 when the artificial intelligence model 1204 determines a confusingly similar trademark in the trademark registry based on the DuPont factors. The first keyword 408 with the semantic meaning 418 to dilute the famous trademark.

The method further includes rejecting the first keyword 408 associated with the semantic meaning 418 from the trademark registration 1206. The method includes applying the artificial intelligence model 1204 to compare the semantic meaning of the first keyword 408 with the semantic meanings of reference marks in a trusted authority database 132 using the DuPont factors. The method includes selecting a confusingly similar mark from the reference marks as likely to be confused with the first keyword 408 based on the DuPont factors. The backend examination engine 706 may continually refine examination and adjudication capabilities by ingesting new trademark registrations, TTAB decisions, and federal court rulings stored in the trusted authority database 132. The backend examination engine 706 may periodically retrain using active learning loops, feedback from a human examiner via the optional escalation module 714, and/or aggregated user behavior data to enhance future decision quality.

The method further includes a computer vision 802 and a machine learning subsystem 804 to authenticate submitted trademark specimens. The machine learning subsystem 804 includes an image processing engine 806 to receive, parse, and/or inspect photographic and graphical evidence submitted with trademark filings. The machine learning subsystem 804 includes a manipulation detection algorithm 808 trained to identify artifacts of digital alteration comprising layering, lassoing, pixel duplication, and/or AI-generated text and graphics indicative of forgery. The machine learning subsystem 804 includes an intent inference model 810 to evaluate contextual metadata and semantic alignment between the specimen and the goods and services claimed. The machine learning subsystem 804 includes an automated classification output 812 to flag suspicious filings for review, provide automated rejection with explanation, and/or clear authentic submissions for continued processing.

The method further includes automatically drafting a proposed argument 1208 in issue, rule, application, and/or conclusion format to support a position on rejection of the first keyword 408 with a confusingly similar trademark in the trademark registry based on the DuPont factors and dilution of a famous trademark.

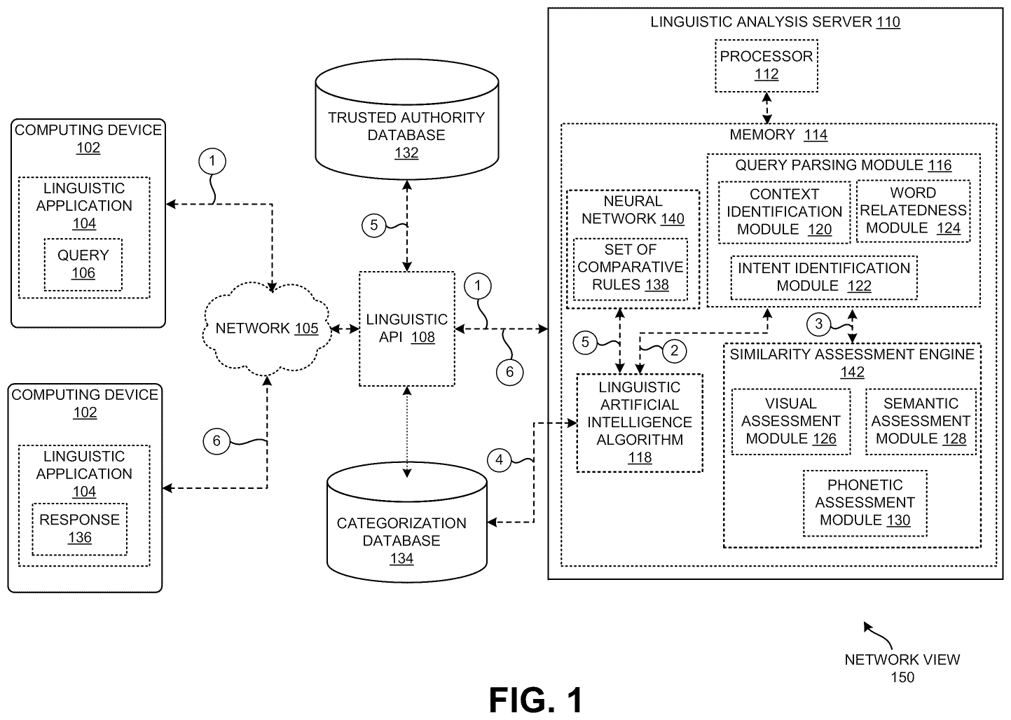

FIG. 1 is a network view 150 illustrating a linguistic analysis server 110 to associate a first written script 404 with a documented string of characters (alphanumeric string of characters 410) of a trusted authority database 132 based on semantic analysis to generate a response 136 to support a position on the similarity between the semantic inference 418 of the first keyword 408 with a second keyword 422, according to one embodiment. Particularly, FIG. 1 illustrates a computing device 102, a linguistic application 104, a query 106, a network 105, an API 108, a linguistic analysis server 110, a processor 112, a memory 114, a query parsing module 116, a linguistic artificial intelligence algorithm 118, a context identification module 120, an intent identification module 122, a word relatedness module 124, a similarity assessment engine 142, a neural network 140, a visual assessment module 126, a semantic assessment module 128, a phonetic assessment module 130, a set of comparative rules 138, a trusted authority database 132, a categorization database 134, and a response 136, according to one embodiment.

The computing device 102 may be an electronic equipment controlled by a CPU that can perform substantial computations, including numerous arithmetic operations and logic operations without human intervention. The computing device 102 may consist of a standalone unit and/or several interconnected units. The computing device 102 may be a personal computer, a desktops, a laptop, a tablet, a hand-held computer, a server, a workstation, a mainframe, a wearable computer, and/or a supercomputer, according to one embodiment.

The linguistic application 104 may be a computer program designed to carry out a specific task of scientific study of language and its structure through natural language processing. The linguistic application 104 may be a computer software designed to performs a specific function of comprehensive, systematic, objective, and precise analysis of all aspects of language, such as—cognitive, social, environmental, biological as well as structural analysis of language directly for an end user and/or, for another application (e.g., linguistic API 108), according to one embodiment.

The query 106 may be a request for data results from the linguistic analysis server 110 to help perform a linguistic analysis on a set of alphanumeric characters (e.g., string of alphanumeric characters 410) to generate a response 136 based on semantic analysis. The query 106 may be a set of alphanumeric characters including a trademark, a trade name, a logo, and/or a unique slogan that is requested by the end user to the linguistic analysis server 110 through the linguistic API 108 to find out similar trademarks, trade name, logo, and/or unique slogan that exist. The query 106 may help a user to ask simple question, perform calculations, combine data from different tables (e.g., from the trusted authority database 132, categorization database 134) and add, change, or delete data from the linguistic analysis server 110. The query 106 may help a user to request an automatically drafted response to the linguistic analysis server 110 based on a proposed argument in issue, rule, application, and conclusion format to support a position on the similarity between the semantic inference of two or more similar and/or dissimilar trademarks, logo designs, trade names, etc. (e.g., first keyword 408 with the second keyword 414), according to one embodiment.

The network 105 may be a set of computers (e.g., computing device 102, collection of computers, servers, mainframes, network devices, peripherals, etc.) and/or other electronic devices that are interconnected for the purpose of exchanging data and/or sharing resources (e.g., over Internet) located on or provided by network nodes. The computing device 102 may be communicatively coupled to the linguistic analysis server 110 through the network 105 to request and/or perform various functions related to linguistic analysis, according to one embodiment.

The linguistic API 108 may be a mechanism that enable two software components to communicate with each other using a set of definitions and protocols. The linguistic API 108 may be a software interface that allows two applications (e.g., linguistic analysis server 110, a mobile application, and linguistic application 104) to interact with each other without any user intervention. The linguistic API 108 may be a collection of software functions and procedures that can be accessed and/or executed using the computing device 102. The linguistic API 108 may be defined as a code that helps two different software's to communicate and exchange data with each other ((e.g., linguistic analysis server 110 and a mobile application), according to one embodiment.

The linguistic analysis server 110 may be a computer program and/or a device that provides a service to another computer program and its user (e.g., client) a study of language, speech units in terms of its constituent parts, content function and other features, to determine the exact state of language (speech) units. The linguistic analysis server 110 may share data as well as share resources and distribute work within the network 105, according to one embodiment.

The processor 112 may be an integrated electronic circuit that responds to and processes the basic instructions that drives the linguistic analysis server 110. The memory 114 may be a device and/or a system that is used to store information for immediate use in the linguistic analysis server 110, according to one embodiment.

The query parsing module 116 may be a distinct software program to configured to perform a specific task of analyzing and interpreting the keywords and phrases (e.g., query 106) entered by users on the linguistic application 104. The query parsing module 116 may contain variables, functions, classes components.

The linguistic artificial intelligence algorithm 118 may be a set of instructions to be followed in calculations or other operations to study of language in the query 106. It includes a software program for the analysis of language form, language meaning, and/or language in context, according to one embodiment.

The context identification module 120 may be a set of instructions to be followed that identifies a linguistic query's (e.g., query 106) real-time contextual situations from sensory data, using pattern recognition, signal processing and machine learning algorithms, according to one embodiment.

The intent identification module 122 may be a set of instructions to be followed for understanding a user's end goal given what they have said or typed in the form of query 106 using the linguistic application 104. The intent identification module 122 may be the first step in turning a human request into a machine-executable command, according to one embodiment.

The word relatedness module 124 may be a set of instructions to be followed to quantify the degree to which two words are associated with each other in a query 106. The word relatedness module 124 may help evaluate the degree of how much one word has to do with another word or a subset of word relatedness. For example, the word relatedness module 124 may evaluate how and/or whether a particular trademark (e.g., first keyword 408) is related to an article of manufacture 402 and/or its classification of goods and services (e.g., using the trusted authority database 132 and categorization database 134) and whether a similar trademark (e.g., second keyword 414) is associated with similar article of manufacture 402 having similar classification of goods and services (e.g., using the trusted authority database 132 and categorization database 134), according to one embodiment.

The similarity assessment engine 142 may be a program that executes the foundation and/or crucial task for other programs to assess the similarity between two entities in a query 106. The similarity assessment engine 142 may create a function that takes a pair of objects (e.g., pair of trademarks or logos forming a query 106) and produces a numerical score quantifying their relatedness. The similarity assessment engine 142 may be a self-contained, but externally-controllable, piece of code that encapsulates powerful logic designed to perform a specific type of work to assess the similarity between two or more entities in the query 106, according to one embodiment.

The neural network 140 may be a series of algorithms that endeavors to recognize underlying relationships in a set of data (e.g., query 106) derived by the linguistic analysis server 110 through a process that mimics the way the human brain operates. The neural network 140 may be a computational learning system that uses a network of functions to understand and translate a data input in the form of query 106 into a desired output to generate a response 136 based on the semantic analysis. The neural network 140 may learn from processing many labeled examples (i.e. data=“query 106” with anwer=“response 136”) that are supplied during training and using this answer key to learn what characteristics of the input (e.g., query 106) are needed to construct the correct output (e.g., response 136). Once a sufficient number of examples have been processed, the neural network 140 may begin to process new, unseen inputs (e.g., query 106) and successfully return accurate results (e.g., response 136). The more examples and variety of inputs the program sees, the more accurate the results typically become because the program learns with experience, according to one embodiment.

In an example embodiment, the neural network 140 may train the linguistic artificial intelligence algorithm 118 through continuous algorithm enhancement of artificial intelligence based learning from a large data set of tens of thousands of successful office action, litigation, and search string models from any one of the trusted authority database 132 and/or other trusted authorities.

The visual assessment module 126 may be a program that executes the foundation and/or crucial task for other programs to assess the visual content of the two or more entities (e.g., trademarks, logos, etc.) in a query 106 to score similarity and/or dissimilarity between two or more entities. The visual assessment module 126 may create a function that takes a pair of objects (e.g., pair of trademarks and/or logos forming a query 106) and produces a numerical score quantifying their relatedness.

The semantic assessment module 128 may be a set of instructions to be followed to draw meaning from text. The semantic assessment module 128 may allow the linguistic analysis server 110 to understand and interpret the query 106 (e.g., sentences, paragraphs, or whole documents), by analyzing their grammatical structure, and identifying relationships between individual words in a particular context. The semantic assessment module 128 may help the linguistic analysis server 110 to automatically extract meaningful information from unstructured data, such as emails, support tickets, and customer feedback, according to one embodiment.

The phonetic assessment module 130 may be a program that executes the foundation and/or crucial task for other programs to assess the phonetic content of two or more entities (e.g., trademarks, logos, first keyword 408, second keyword 422, etc.) in a query 106 to score similarity and/or dissimilarity between two or more entities (e.g., trademarks, logos, etc.). The phonetic assessment module 130 may create a function that takes a pair of objects (e.g., pair of trademarks and/or logos forming a query 106) and produces a numerical score quantifying their relatedness, according to one embodiment.

The set of comparative rules 138 may be a collection of relative orders that forms a basis of an arguable similarity between a the first keyword 408 and the second keyword 408 in a set of languages in the first written script 404 (e.g., trademarks, logos, trade name, etc.) on an article of manufacture 402. In one example embodiment, the set of comparative rules 138 may be a set list of factors to determine the scope of a trademark whether there is “likelihood of confusion”, between a particular trademark and another trademark in the minds of the consuming public. These factors called DuPont factors may form the basis of set of comparative rules 138 and may include determining the similarity and/or dissimilarity of the trademarks in their entireties as to appearance, sound, connotation, and/or commercial impression. The similarity and/or dissimilarity and nature of the goods described in an application or registration or in connection with which a prior mark is in use. The similarity of the marks, the similarity of the goods or services on which the marks are or will be used, and the conceptual and commercial strength of the senior mark may be determined using the set of comparative rules 138, according to one embodiment.

According to one embodiment, the set of comparative rules 138 may include:
1. The similarity or dissimilarity of the marks (e.g., trademarks, logos, first keyword 408, second keyword 422, etc.) in their entireties as to appearance, sound, connotation, and commercial impression.
2. The similarity or dissimilarity and nature of the goods (e.g., article of manufacture 402) . . . described in an application or registration (e.g., trademarks, logos, etc.) or in connection with which a prior mark is in use.
3. The similarity or dissimilarity of established, likely-to-continue trade channels (e.g., using the web page 405).
4. The conditions under which and buyers to whom sales are made, i.e. “impulse” vs. careful, sophisticated purchasing.
5. The fame of the prior mark.
6. The number and nature of similar marks in use on similar goods (e.g., using the categorization database 134 of the linguistic analysis server 110).
7. The nature and extent of any actual confusion (e.g., using the linguistic artificial intelligence algorithm 118 of the linguistic analysis server 110).
8. The length of time during and the conditions under which there has been concurrent use without evidence of actual confusion (e.g., using the linguistic artificial intelligence algorithm 118 of the linguistic analysis server 110).
9. The variety of goods (e.g., determined using the categorization database 134 of the linguistic analysis server 110) on which a mark is or is not used.
10. The market interface between the applicant and the owner of a prior mark (e.g., using the web page 405 of the linguistic analysis server 110).
11. The extent to which applicant has a right to exclude others from use of its mark on its goods.
12. The extent of potential confusion (e.g., first keyword 408, second keyword 422, etc.).
13. Any other established fact probative of the effect of use.

The trusted authority database 132 may be an electronic repository of special authoritative and/or confidential services that is trusted by identities (e.g., people, businesses, governments and so on) either by some positive action or by default. The trusted authority database 132 may include an organized collection of structured information of registered live and dead trademarks, logos, trade names, etc. that may be used in commerce, according to one embodiment.

The categorization database 134 may be a method of arranging the goods and services into groups called classification. The goods and services may be classified into groups based on their characteristics in the categorization database 134. The categorization database 134 may be a repository of class and/or category a particular goods and services belongs to, according to its characteristics.

The response 136 may be an automatically generated reply of the linguistic analysis server 110 in the form of written script to answer a query 106. The query 106 may include a trademark, a trade name, a logo, and/or a unique slogan that is requested to the linguistic analysis server 110 to find out similar trademarks, trade name, logo, and/or unique slogan that exist. The linguistic artificial intelligence algorithm 118 of the linguistic analysis server 110 may perform a linguistic analysis on a set of alphanumeric characters (e.g., string of alphanumeric characters 410) derived from the query 106 to find out similar trademarks, trade name, logo, and/or unique slogan from the trusted authority database 132 based on the similarity and/or dissimilarity of the trademarks, trade name, logo, and/or unique slogan. The linguistic artificial intelligence algorithm 118 may further generate a response 136 based on semantic analysis of the similar trademark, similar trade name, similar logo, and/or similar slogan found in the trusted authority database 132. The neural network 110 of the linguistic analysis server 110 may automatically draft a proposed argument in issue, rule, application, and conclusion format to support a position on the similarity (and/or similarity) between the semantic inference 418 of the first keyword 408 with the second keyword 414 (e.g., in the query 106, trademarks, trade name, logo, and/or unique slogan).

In an example embodiment, the linguistic analysis server 110 may generate a list of a suggested trademark classifications by applying a trademark classification determination artificial intelligence algorithm (e.g., using the neural network 140) that quantifiably predicts chances of success and applicability of the first keyword 408 to the trademark classification determination based on the associating the first keyword 408 formed with the alphanumeric string of characters 410 in the first written script 404 with the semantic meaning based on the semantic analysis.

In circle “1”, a user may submit a query 106 (e.g., entities, pair of objects, trademarks or logos forming a query 106) to the linguistic analysis server 110 through a linguistic application 104 using a computing device 102 communicatively coupled to the the linguistic analysis server 110 via a network 105. In circle “2”, the query parsing module 116 may analyze and interpreting the keywords and phrases (e.g., query 106) entered by users on the linguistic application 104 using the context identification module 120, the intent identification module 122, and the word relatedness module 124. In circle “3”, the similarity assessment engine 142 may assess the similarity between two entities in the query 106 using the visual assessment module 126, the semantic assessment module 128 and the phonetic assessment module 130 derived from the trusted authority database 132. In circle “4”, the linguistic artificial intelligence algorithm 118 may extract the categorization (e.g., classification of goods and services of the pair of objects forming a query 106) of the respective entities from the categorization database 134. In circle “5”, the linguistic artificial intelligence algorithm 118 may extract similar entities from the trusted authority database 132 based on the semantic analysis of the query 106 (e.g., entities, pair of objects, trademarks or logos forming a query 106). In circle “6”, the neural network 140 may draft a response 136 based on the set of comparative rules of the linguistic analysis server 110 to send to the user via the linguistic application 136, according to one embodiment.

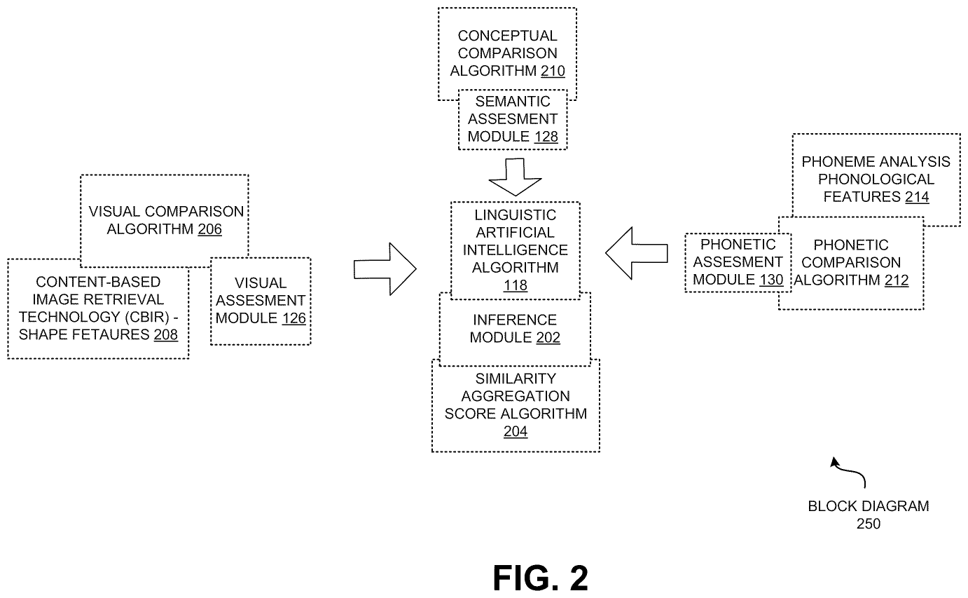

FIG. 2 is a block diagram 250 illustrating the semantic analysis module 128 and an inference module 202 of the linguistic analysis server 110 of FIG. 1, according to one embodiment. Particularly, FIG. 2 builds on FIG. 1, and further adds a inference module 202. The inference module 202 may be a set of instructions to be followed to derive a conclusion whether a trademark, a logo, a slogan, and/or a trade name forming the query 106 is similar and/or dissimilar to an existing trademark, logo, slogan, and/or trade name on the basis of evidence and reasoning. The phonetic assessment module 130 may be a set of instructions to be followed to assess the speech sounds, their production, and/or their transcription in written symbols in the the query 106, according to one embodiment.

The phonetic comparison algorithm 212 may conduct a phoneme analysis of phonological features 214 to analyze the similarity and dissimilarity of the trademark, logo, slogan, and/or trade name forming the query 106 (first keyword 408, second keyword 422). The visual assessment module 126 of the linguistic analysis server 110 may be a set of instructions to be followed to retrieve a similar image from the trusted authority database 132. The visual comparison algorithm 206 may use a Content-based image retrieval (CBIR) technology shape features 208 in which for a given query 106 image (e.g., logo, trademark, etc.), similar images are retrieved from the trusted authority database 132 based on their content similarity and categorization. The semantic assessment module 128 of the linguistic analysis server 110 may use a conceptual comparison algorithm 210 to analyse the similarity between two entities in the query 106. The similarity aggregation score algorithm 204 may be set of instructions to be followed to produce an aggregate numerical score quantifying the similarity and/or similarity of a pair of objects forming the query 106. The aggregate numerical score quantifying the similarity and/or similarity may help linguistic analysis server 110 generate an appropriate response 136 containing a proposed argument in issue, rule, application, and conclusion format to support a position on the similarity between the semantic inference of the pair of objects forming the query 106 (e.g., first keyword 408, second keyword 422), according to one embodiment.

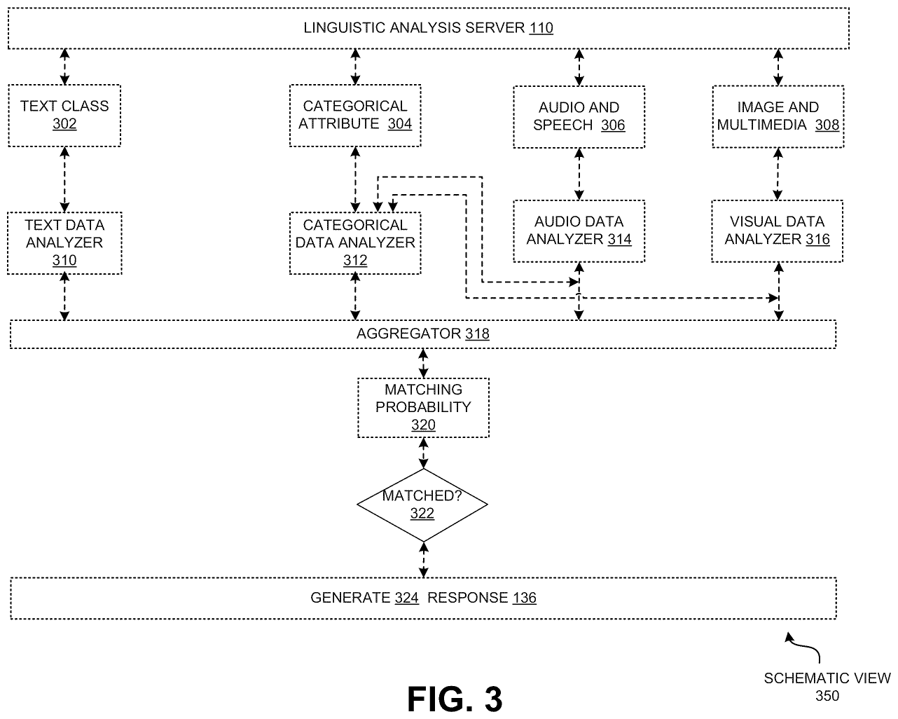

FIG. 3 is a schematic view 350 of the linguistic analysis server 110 of FIG. 1 illustrating the semantic analysis layers of the system, according to one embodiment. The linguistic analysis server 110 may receive a query 106 in the form of a pair of logos, trademarks, trade names, and/or unique logos. The query parsing module 116 may parse the input data (e.g., query 106) to derive its text class 302, categorical attribute 304, audio and speech 306 of the input data, and the image and multimedia 308 content of the input data. The linguistic artificial intelligence algorithm 118 may use the text data analyzer 310 derive the class of the input data, audio data analyzer 314 and visual data analyzer 316 to derive respective category of the input data. Based on the categorical attribute 304, audio data analyzer 314 and visual data analyzer 316, the categorical data analyzer 314 may derive the respective classification of the input data from the categorization database 134 for the goods and services. The aggregator 318 may generate a matching probability 320 score based on the similarity and/or dissimilarty (e.g., using decision function matched? 322) of the pair of logos, trademarks, trade names, and/or unique logos the input data (e.g., query 106). The linguistic analysis server 110 may generate 324 a response 136 based on the matching probability 320 score of the aggregator 318, according to one embodiment.

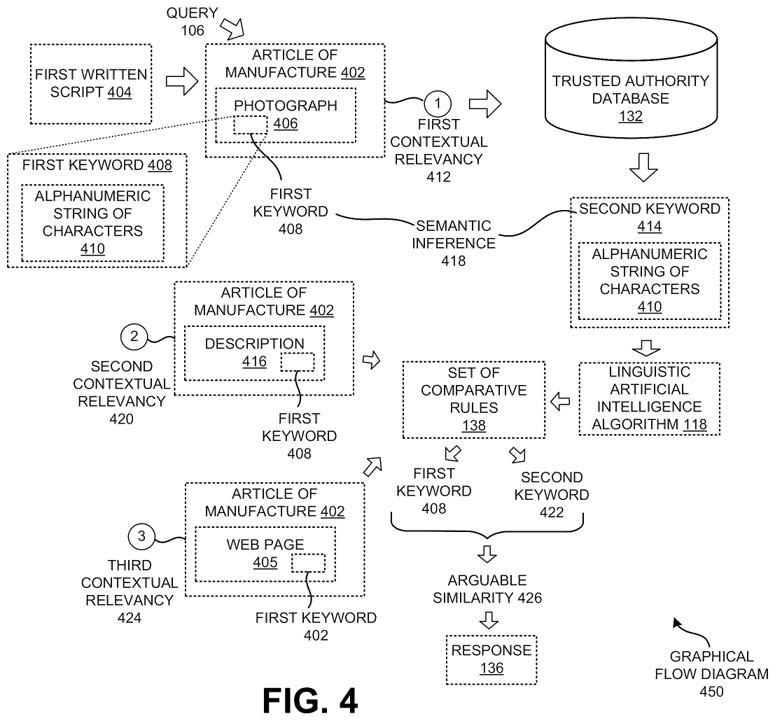

FIG. 4 is a graphical flow diagram 450 of the linguistic analysis server 110 of FIG. 1 illustrating steps of the linguistic analysis server 110 to associate a first written script 404 with a documented string of characters (e.g., alphanumeric string of characters 410) of a trusted authority database 132 based on semantic analysis to generate a response 136 to support a position on the similarity (e.g., arguable similarity 426) between the semantic inference 418 of the first keyword 408 with a second keyword 422, according to one embodiment. A user may request to determine whether a likelihood of confusion exists between a particular trademark and a number of other trademarks. The user may submit a query 106 of the particular trademark (e.g., first written script 404) and a number of other trademarks through the linguistic application 104 to generate an automatic response using linguistic analysis server 110. The linguistic analysis server 110 may form a first keyword 408 from a first written script 404 on an article of manufacture 402. The first keyword 408 may include an alphanumeric string of characters 410. The linguistic analysis server 110 may derive the first contextual relevancy 412 in circle “1” of a photograph 406 affixed on the article of manufacture 402 bearing a visual impression of the first keyword 408 based on the semantic analysis. The linguistic analysis server 110 may derive the first contextual relevancy 412 by using the context identification module 120, the intent identification module 122, and the word relatedness module 124, according to one embodiment.

The linguistic analysis server 110 may derive the second contextual relevancy 420 in circle “2” of the description 416 of the article of manufacture 402 on which the first keyword 408 is affixed to determine the categorization and classification of the article of manufacture 402 from the categorization database 134. The linguistic analysis server 110 may further derive the third contextual relevancy 424 in circle “3” of the first keyword 408 affixed on a web page 405 through a screenshot bearing the visual impression of first keyword 408. The linguistic analysis server 110 may associate the first keyword 408 with a semantic meaning based on above analysis and may compare the first keyword 408 with a second keyword 422 having a known semantic meaning as documented in a trusted authority database 132. The linguistic analysis server 110 may apply the linguistic artificial intelligence algorithm 118 upon the first keyword 408 and the second keyword 422 to determine which of the set of comparative rules 138 form a basis of an arguable similarity 426 between the first keyword 408 and the second keyword 422. Accordingly, the neural network 140 of the linguistic analysis server 110 may generate the response 136 based on the arguable similarity 426, according to one embodiment.

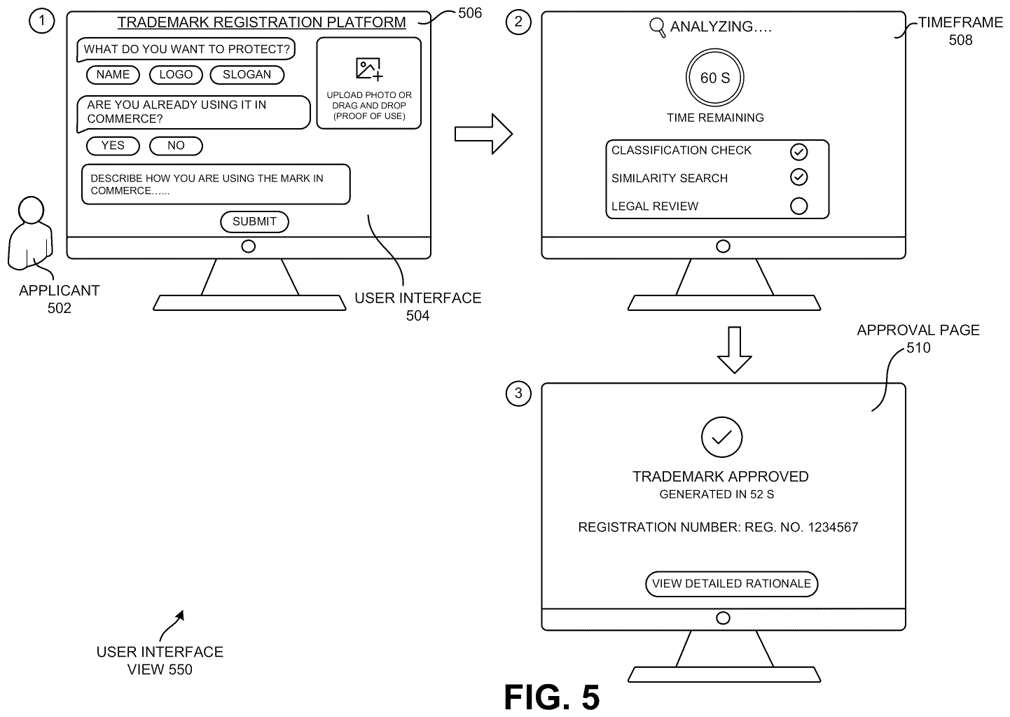

FIG. 5 is a user interface view 550 of a computer-implemented platform for automating evaluation and registration of a trademark using the linguistic analysis server 110 of FIG. 1, according to one embodiment. FIG. 5 illustrates an applicant 502, a user interface 504, a trademark registration platform 506, a timeframe 508, an approval page 510, according to one embodiment.

The applicant 502 may be a human, an individual and/or a filing agent to submit mark data for evaluation and registration. The applicant 502 may provide a proposed word mark, logo, and/or slogan, supply a textual description of goods and/or services, indicate proof-of-use status, and confirm data via a submission control. Interaction may occur through on-screen controls on the trademark registration platform 506 rendered via the user interface 504, according to one embodiment.

The user interface 504 may be a client-facing display environment executed on the computing device 102 and configured to render a plurality of screens, capture input, and/or exchange messages with remote AI services over the network 105. The user interface 504 may render the trademark registration platform 506, the timeframe indicator 508, and the approval page 510 to accept including but not limited to text entries, control selections, and/or proof-of-use image uploads to transmit a structured payload for automated analysis, according to one embodiment.

The trademark registration platform 506 may be a data-capture interface rendered within the user interface 504 on a display of computing device 504. The trademark registration platform 506 may present structured input controls for entry of a proposed trademark and related metadata. The trademark registration platform 506 may normalize inputs entered by the applicant 502 and guide compliant submission. Controls may include but not limited to a button group for selection of name, logo, and/or slogan, a commerce-use prompt with YES and NO selectors, a conditional drag-and-drop zone labeled proof-of-use for imagery captured from packaging, labeling, web pages, and/or point-of-sale materials, and/or a multiline field for description of goods and services and usage in commerce, according to one embodiment.

Built-in validation on the trademark registration platform 506 may enforce required fields, harmonize terminology with standardized taxonomies, and prepare a submission payload. Submit control on the trademark registration platform 506 may assemble selected mark type, descriptive text, and any uploaded proof-of-use file into a validated record and transmit the record from the user interface 504 to a classification engine 704 for class suggestions and to a backend examination engine 706 for real-time similarity checks across registered, pending, and/or common-law marks. The same record may enqueue analysis by a legal reasoning module 710 for precedent interpretation, disclaimer evaluation, and/or registration criteria assessment. Returned outputs from the classification engine 704 and the backend examination engine 706 and the legal reasoning module 710 may be routed back to the user interface 504 for display on the timeframe indicator 508 and the approval page 510, according to one embodiment.

The timeframe indicator 508 may be a progress display rendered within the user interface 504 on a display of computing device 504. The timeframe indicator 508 may communicate a short predefined processing window and/or stage completion during automated examination. The page may include but not limited to a circular countdown dial showing remaining seconds (e.g. 60 seconds), and/or a checklist labeled “Classification Check,” “Similarity Search,” and/or “Legal Review”, according to one embodiment.

Submit button on the trademark registration platform 506 may initiate a process at the classification engine 704, the backend examination engine 706, the legal reasoning module 710, and an outcome generation engine 712 through the linguistic application 104 over the network 105. The timeframe indicator 508 may subscribe to status messages and/or event flags published by the classification engine 704, the backend examination engine 706, the legal reasoning module 710, update the countdown dial, advance the progress bar, and/or switch checklist icons from pending to complete as each stage completes. Receipt of a decision-ready signal from the outcome generation engine 712 may cause the timeframe indicator 508 to trigger navigation to the approval page 510 and record start and finish timestamps in the memory 114 for audit logging, according to one embodiment.

The approval page 510 may be a decision view to present an automated outcome and a navigation path to reasoning details. The approval page 510 may display “TRADEMARK APPROVED” with a generated registration number and/or “TRADEMARK REFUSED” with a reason summary, and may include a “VIEW DETAILED RATIONALE” button, according to one embodiment.

Content for the approval page 510 may be produced by the outcome generation engine 712 and linked to rationale compiled by the legal reasoning module 710 using DuPont-factor analysis, with downstream access to amendment suggestions, disclaimer proposals, class narrowing, and/or appeal options, according to one embodiment.

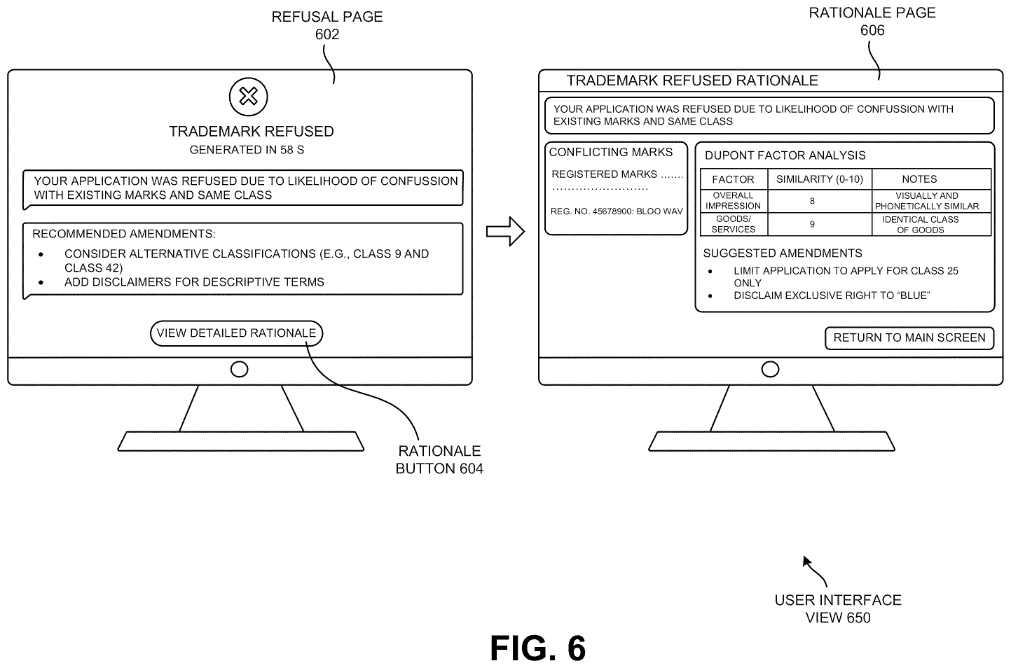

FIG. 6 is a user interface view 650 illustrating a refusal page 602 and a rationale page 606 of the computer-implemented platform for automating evaluation and registration of the trademark using the linguistic analysis server 110 of FIG. 1, according to one embodiment. FIG. 6 illustrates a refusal page 602, a rationale button 604, and a rationale page 606, according to one embodiment.

The refusal page 602 may be a decision view configured to present a preliminary refusal generated within a short predefined time frame. The refusal page 602 may display a “TRADEMARK REFUSED”, a generation timestamp, a concise reason summary derived from similarity findings, and/or a list labeled “Recommended Amendments” including alternative classes and/or disclaimer proposals, according to one embodiment.

The refusal page 602 may present the rationale button 604 to request expanded analysis. Content displayed on the refusal page 602 may originate from the outcome generation engine 712 after the backend examination engine 706 identifies conflicts across registered, pending, and/or common-law marks stored in the trusted authority database 132 and scored under DuPont factors by the legal reasoning module 710, according to one embodiment.

The rationale button 604 may be an activation button enabling retrieval of detailed reasoning. Upon selection, the rationale button 604 may send an event to the linguistic application 104, the linguistic application 104 may call the legal reasoning module 710 through the linguistic API 108. The legal reasoning module 708 may assemble sections including a DuPont-factor table, a conflicting-marks list with registration number, and/or amendment guidance referencing disclaimer language and/or class narrowing. The assembled package may be returned to the user interface 504 for presentation on the rationale page 606 and stored in the memory 114 for audit logging, according to one embodiment.

The rationale page 606 may be an expanded explanation view presenting a structured legal analysis for an amendment and/or appeal. The rationale page 606 may include a banner titled “Trademark Refused Rationale,” a reason statement, a Conflicting Marks panel listing cited registrations, the DuPont Factors Analysis grid showing factor names, similarity scores, and explanatory notes, a Suggested Amendments panel listing class-limitation, disclaimer recommendations, and/or a Return to Main Screen button for navigation, according to one embodiment.

Data shown on the rationale page 606 may be compiled by the legal reasoning module 710 using findings delivered from the backend examination engine 706, rules sourced from the set of comparative rules 138, and precedents maintained within the trusted authority database 132, the outcome generation engine 710 may format the compilation for end-user display, according to one embodiment.

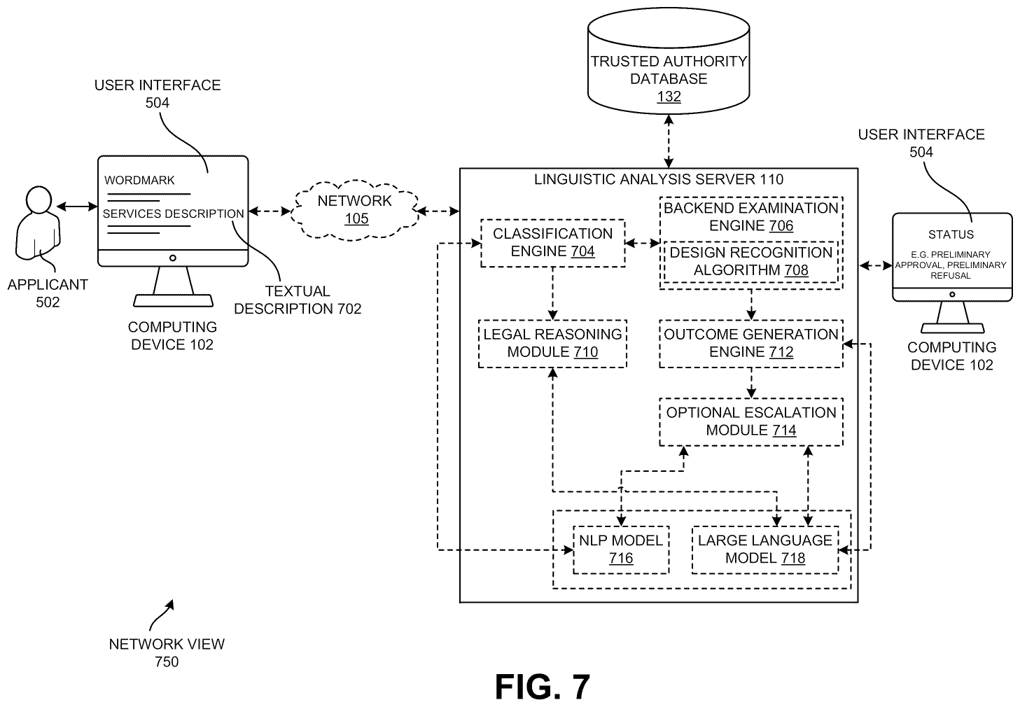

FIG. 7 is a network view 750 of the linguistic analysis server of FIG. 1 illustrating the computer-implemented platform for automating evaluation and registration of a trademark providing a legal reasoning for trademark approval and/or rejection via a computing device 102 communicatively coupled to the linguistic analysis server 110, according to one embodiment. FIG. 7 illustrates a textual description 702, a classification engine 704, a backend examination engine 706, a design recognition algorithm 708, a legal reasoning module 710, an outcome generation engine 712, an optional escalation module 714, an NLP model 716, and a large language model 718, according to one embodiment.

The textual description 702 may be a structured natural-language input field rendered within the user interface 504 for capture of goods and services identifications, channels of trade, use-in-commerce context, and/or references to specimen sources. The textual description 702 may be the primary semantic signal for downstream automation by supplying terms and phrases to map to standardized taxonomies and DuPont-factor attributes, according to one embodiment.

The textual description 702 may be normalized, tokenized, and/or vectorized, then transmitted over the network 105 to the classification engine 704 for class prediction using the NLP model 716 and to the backend examination engine 706 for construction of semantic and phonetic search queries against the trusted authority database 132. Extracted features from the textual description 702 may be forwarded to the legal reasoning module 710 supported by the large language model 718 for precedent interpretation, disclaimer evaluation, and suggested amendments, while a copy of the textual description 702 may be persisted in the memory 114 and the categorization database 134 for audit logging and model refinement, according to one embodiment.

The classification engine 704 may be a server-side subsystem hosted within the linguistic analysis server 110 and orchestrated through the linguistic API 108 to map input of the applicant 502 to standardized trademark taxonomies. The classification engine 704 may convert the textual description 702 and/or mark metadata from the user interface 504 into a plurality of predicted classes of goods and services (e.g., Nice classes) with confidence scores, exemplar identifications, and/or rationale snippets, thereby constraining downstream search scope and fee estimation, according to one embodiment.

The classification engine 704 may ingest a structured payload comprising the textual description 702, declared mark type, and optional specimen cues. The classification engine 704 may perform language detection, tokenization, lemmatization, and/or named-entity extraction. The classification engine 704 may generate vector embedded key terms using NLP model 716, and compute similarity against class descriptors, ID Manual entries, and/or prior classification exemplars retrieved from the categorization database 134 and/or the trusted authority database 132. The classification engine 704 may rank candidate classes, detect multi-class coverage, propose narrower identifications, and/or generate feature-attribution explanations citing matched phrases and precedent examples, according to one embodiment.

The classification engine 704 may transmit predicted classes and rationales to the user interface 504 for confirmation, forward normalized class selections to the backend examination engine 706 for targeted similarity searches, and publish progress and confidence metrics to the timeframe 508 and the outcome generation engine 712. The classification engine 704 may log features and outcomes for active-learning, according to one embodiment.

The backend examination engine 706 may be a server-side analysis component withing the linguistic analysis server 110 configured to conduct real-time similarity and conflict evaluation for a proposed trademark. The backend examination engine 706 may accept a normalize case file from the classification engine 704 including the textual description 702, selected classes, and/or uploaded mark assets, then query the trusted authority database 132 and the categorization database 134 for registered, pending, and common-law references, according to one embodiment.

For word and slogan content the backend examination engine 706 may generate semantic vectors using the NLP model 716 and compute comparison scores against candidate references. For logo and image content the backend examination engine 706 may invoke the design recognition algorithm 708 to derive visual descriptors and perform nearest-neighbor retrieval and visual similarity scoring. The backend examination engine 706 may fuse semantic and visual evidence, weight features by DuPont-factor signals including but not limited to overall commercial impression and goods and services overlap, rank conflicting references, and assemble a structured finding set with scores, excerpts, and/or image thumbnails, according to one embodiment.

The backend examination engine 706 may publish stage updates to the timeframe 508, persist intermediate artifacts in the memory 114 and/or logs. The backend examination engine 706 may forward the finding set to the legal reasoning module 710 for precedential interpretation, and provide a status object to the outcome generation engine 712. When ambiguity exceeds a configured threshold, the backend examination engine 706 may route the case to optional escalation module 714 for human review, according to one embodiment.

The design recognition algorithm 708 may be a computer vision 802 routine integrated with the backend examination engine 706 and hosted on the linguistic analysis server 110 to quantify visual similarity among trademarks. The design recognition algorithm 708 may perform feature extraction on uploaded marks and/or specimen imagery, including but not limited to contour topology, stroke geometry, keypoint descriptors, spatial layout of graphic elements, stylized lettering characteristics, color and contrast statistics, and/or may generate compact visual embeddings suitable for large-scale nearest-neighbor search, according to one embodiment.

The design recognition algorithm 708 may normalize incoming imagery (resize, de-noise, background suppression), detect and segment mark regions from packaging and/or screenshots, perform optional OCR (optical character recognition) to capture embedded text. The design recognition algorithm 708 may fuse visual embeddings with textual cues received from the classification engine 704 and the NLP model 716, according to one embodiment.

The design recognition algorithm 708 may query reference corpora stored in the trusted authority database 132 to retrieve candidate registered, pending, and/or common-law designs, calculate similarity scores, and produce a ranked conflict list with rationale features (e.g., shared shapes, arrangement, stylization). The design recognition algorithm 708 may emit structured findings to the backend examination engine 706 for aggregation with semantic and phonetic signals, deliver weighted inputs for DuPont-factor assessment by the legal reasoning module 710, and/or publish stage updates to the timeframe 508 via the linguistic application 104 accessed through the linguistic API 108, according to one embodiment.

The legal reasoning module 710 may be an LLM (large language model) driven adjudicative component configured for trademark-law interpretation within the computer-implemented platform. The legal reasoning module 710 may translate technical findings into legally grounded conclusions by applying statutory criteria, disclaimer requirements, and/or DuPont factor analysis using an internal adversarial process to simulate multiple examiner and advocate perspectives.

The legal reasoning module 710 may ingest a finding set from the classification engine 704 and the backend examination engine 706, including matched references, goods and services alignments, semantic and phonetic features, and/or visual-similarity features produced by the design recognition algorithm 708. The legal reasoning module 710 may retrieve controlling and persuasive authorities from the trusted authority database 132, apply the set of comparative rules 138 to evaluate likelihood of confusion and dilution, detect absolute bars and disclaimer needs, and/or weight factor-by-factor evidence to generate a reasoned outcome. The legal reasoning module 710 may produce a structured rationale object containing written findings of fact, legal analysis in IRAC (issue, rule, application, and conclusion) format, proposed amendments comprising class narrowing and disclaimers, and explicit citations to TTAB and/or court decisions, according to one embodiment.

The legal reasoning module 710 may deliver the rationale object to the outcome generation engine 712 for decision synthesis, to a timeframe indicator 508 for progress signaling, and/or to an optional escalation module 714 when ambiguity exceeds a configured threshold. The legal reasoning module 710 may execute on the linguistic analysis server 110 via the linguistic API 108, use the processor 112 for inference, and persist intermediate working notes and final analyses in the memory 114 for audit logging and/or subsequent appeal workflows, according to one embodiment.

The outcome generation engine 712 may be a decision-synthesis component configured to convert analytical findings into a registrability outcome within a short predefined time frame. The outcome generation engine 712 may receive a rationale object from the legal reasoning module 710 together with classification suggestions from the classification engine 704, similarity and conflict results from the backend examination engine 706, and/or visual comparison features from a design recognition algorithm 708, according to one embodiment.

The outcome generation engine 712 may aggregate evidentiary signals, evaluate decision thresholds derived from the set of comparative rules 138, and select a disposition including a preliminary approval with automated registration and/or a preliminary refusal with detailed explanation and recommended amendments. The outcome generation engine 712 may, upon approval conditions, request assignment of a registration number from a registry service and assemble registration metadata linked to goods and services classifications from the categorization database 134, according to one embodiment.

The outcome generation engine 712 may, upon refusal conditions, format an editable IRAC style response citing controlling precedent, proposed disclaimers, and/or class-narrowing language supplied by the legal reasoning module 710. The outcome generation engine 712 may publish stage updates to the timeframe 508, deliver decision payloads to the user interface 504 for rendering on the approval page 510 and/or the refusal page 602, and signal the optional escalation module 714 when ambiguity metrics exceed configured bounds. The outcome generation engine 712 may execute on the linguistic analysis server 110 through the linguistic API 108, utilize the processor 112 for inference-time orchestration, persist artifacts in the memory 114 for immutable audit logging, and/or return machine readable outputs to downstream modules for appeals processing and analytics, according to one embodiment.

The optional escalation module 714 may be a human-review orchestration component integrated with the linguistic analysis server 110 through the linguistic API 108. The optional escalation module 714 may manage applications exhibiting novelty, ambiguity, and/or high-risk DuPont-factor signals by coordinating assignment to designated human examiner and by merging examiner feedback into downstream automation, according to one embodiment.

The optional escalation module 714 may receive ambiguity metrics, edge-case flags, and/or borderline likelihood-of-confusion scores from classification engine 704, backend examination engine 706, legal reasoning module 710, and outcome generation engine 712. The optional escalation module 714 may assemble a case packet including the textual description 702, selected classes, referenced prior marks, visual descriptors from the design recognition algorithm 708, rationale excerpts from the legal reasoning module 710, and timeline events from the timeframe 508, then dispatch the case packet to a reviewer console over secure workflow endpoints, according to one embodiment.

The optional escalation module 714 may ingest reviewer determinations, redlines, and/or training annotations, persist the artifacts in the memory 114 for audit logging, and/or publish normalized dispositions to the outcome generation engine 712 for finalization. The optional escalation module 714 may export curated corrections and labeling signals to active-learning pipelines to support the classification engine 704 and the backend examination engine 706, according to one embodiment.

The NLP model 716 may be a server-side natural-language representation model hosted on the linguistic analysis server 110 and exposed to platform services through the linguistic API 108. The NLP model 716 may transform mark descriptions and goods and services narratives into semantic vectors for class prediction, conflict retrieval, and/or similarity scoring, according to one embodiment.

The NLP model 716 may perform language detection, tokenization, lemmatization, and/or named-entity recognition on the textual description 702 and on authority-sourced descriptors from the categorization database 134 and the trusted authority database 132. The NLP model 716 may compute dense embeddings for keywords, classes, and/or specimen-derived captions. The NLP model 716 may support multilingual representations for cross-language comparison, and return similarity measures aligned to DuPont-factor dimensions including connotation and commercial impression, according to one embodiment.

The Classification engine 704 may consume embeddings from the NLP model 716 to rank candidate classes and propose narrowed identifications, while the backend examination engine 706 may consume the same embeddings to locate semantically proximate registered, pending, and common-law references. The NLP model 716 may emit feature attribution maps identifying phrases driving scores, log vector statistics in the memory 114 for diagnostics, and provide batched inference services via the processor 112 for high throughput workloads, according to one embodiment.

The large language model 718 may be a legal-reasoning generative model hosted on the linguistic analysis server 110 and accessed through the linguistic API 108 to perform autonomous precedent interpretation and structured drafting. The large language model 718 may translate technical similarity findings into legally grounded conclusions using the set of comparative rules 138 and DuPont-factor frameworks, according to one embodiment.

The large language model 718 may ingest a finding set received from the backend examination engine 706, class proposals from the classification engine 704, visual-similarity rationales from the design recognition algorithm 708, and authority snippets retrieved from the trusted authority database 132. The large language model 718 may run an internal adversarial analysis simulating a plurality of examiner and advocate viewpoints, weigh factor-by-factor evidence, detect disclaimer needs and/or absolute bars, and generate the rationale object in IRAC format with citations to TTAB decisions and court rulings, according to one embodiment.

The outcome generation engine 712 may consume the rationale object for decision synthesis and for creation of editable refusal responses and/or approval summaries. The large language model 718 may publish progress signals to timeframe 508, route uncertainty metrics to the optional escalation module 714, persist working notes and conclusions in the memory 114 for audit and appeals, and support prompt-templated reuse for consistent reasoning across cases, according to one embodiment.

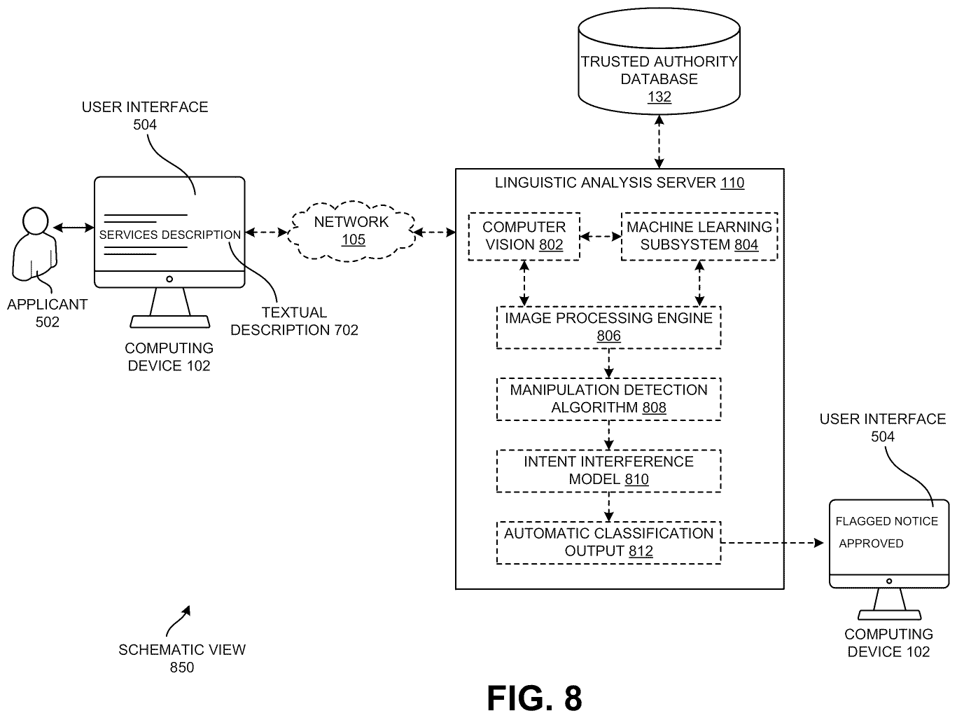

FIG. 8 is a schematic view 850 of the linguistic analysis server 110 of FIG. 1 illustrating a machine learning subsystem 804 for authenticating trademark specimens, according to one embodiment. FIG. 8 illustrates a computer vision 802, a machine learning subsystem 804, an image processing engine 806, a manipulation detection algorithm 808, an intent inference model 810, and an automatic classification output 812, according to one embodiment.

The computer vision 802 may be a perceptual-analysis layer hosted within the linguistic analysis server 110 and orchestrated through the linguistic API 108 to transform uploaded specimen imagery into machine-usable features for trademark evaluation. The computer vision 802 may provide core functions for region detection, mark segmentation, geometric normalization, multi-scale feature extraction, optical character recognition, and visual-embedding generation to support downstream authentication and conflict analysis, according to one embodiment.

The computer vision 802 may receive images and/or screenshots from user interface 504 via network 105, invoke the image processing engine 806 for resize, de-noise, background suppression, and foreground isolation, and produce feature maps describing contour topology, stroke geometry, icon layout, texture fields, and/or typographic attributes. The computer vision 802 may export compact embeddings to the design recognition algorithm 708 for nearest-neighbor retrieval and visual similarity scoring, deliver cropped regions and OCR text to the manipulation detection algorithm 808 and intent interference model 810, and merge visual cues with wording embeddings from the NLP model 716 to enhance goods and services alignment, according to one embodiment.

The computer vision 802 may write intermediate tensors and saliency masks to the memory 114, utilize the processor 112 for accelerated inference, query the trusted authority database 132 for genuine-specimen exemplars to calibrate thresholds, and return status updates to the outcome generation engine 712 and the automatic classification output 812 for decision synthesis and user feedback, according to one embodiment.

The machine learning subsystem 804 may be a model-orchestration layer within the linguistic analysis server 110, exposed through the linguistic API 108, to manage training, selection, and inference of predictive models used across trademark authentication and examination. The machine learning subsystem 804 may host a registry of versioned models for the computer vision 802, the design recognition algorithm 708, the manipulation detection algorithm 808, and the intent interference model 810. The machine learning subsystem 804 may maintain a shared feature store fed by the image processing engine 806 and the NLP model 716, according to one embodiment.

The machine learning subsystem 804 may monitor performance, bias, and/or drift against benchmarks sourced from the trusted authority database 132. The machine learning subsystem 804 may ingest structured payloads containing the textual description 702, class selections from the classification engine 704, and specimen imagery. The machine learning subsystem 804 may normalize features, select an optimal model ensemble using validation scores, and execute inference on processor 112 to produce embeddings, similarity scores, authenticity probabilities, and/or intent-alignment signals, according to one embodiment.

The machine learning subsystem 804 may route visual and semantic outputs to the backend examination engine 706 for conflict retrieval, to the intent interference model 810 for context checks, to the automatic classification output 812 for flag and/or approve decisions, and to the outcome generation engine 712 for decision synthesis. The machine learning subsystem 804 may persist training artifacts and inference logs in the memory 114, schedule active-learning updates using adjudicated outcomes and human review feedback from the optional escalation module 714, and publish status events to the timeframe 508 for user feedback, according to one embodiment.

The image processing engine 806 may be a server-side preprocessing pipeline within the linguistic analysis server 110, invoked through the linguistic API 108, to prepare proof-of-use imagery for downstream authentication and comparison. The image processing engine 806 may accept photographs, screenshots, packaging labels, and web page captures uploaded through user interface 504, together with the textual description 702 and class selections from the classification engine 704, according to one embodiment.

The image processing engine 806 may decode files, extract EXIF and network metadata, compute cryptographic hashes for chain-of-custody, and normalize inputs by resizing, color-space conversion, de-noising, de-blurring, illumination correction, and/or perspective/deskew adjustment. The image processing engine 806 may segment mark regions from backgrounds using foreground masks, draw bounding boxes for word and figurative elements, generate multi-scale tiles, and/or run OCR preprocessing to enhance embedded text. Feature tensors and thumbnails produced by the image processing engine 806 may feed the computer vision 802 for embedding generation, the manipulation detection algorithm 808 for forgery cues, and the intent interference model 810 for context alignment with the textual description 702, according to one embodiment.

The image processing engine 806 may consult the trusted authority database 132 for reference layout patterns, pass cleaned artifacts to the machine learning subsystem 804 for model selection and inference, and deliver structured outputs to the backend examination engine 706 and the automatic classification output 812. Intermediate artifacts and provenance logs may persist in the memory 114, according to one embodiment.

The manipulation detection algorithm 808 may be a forensic-analysis subsystem within the linguistic analysis server 110, orchestrated via the linguistic API 108, configured to authenticate proof-of-use imagery and detect digital alteration. The manipulation detection algorithm 808 may receive normalized crops, tiles, and metadata from the image processing engine 806 together with the textual description 702, class selections from the classification engine 704, and provisional embeddings from the computer vision 802, according to one embodiment.

The manipulation detection algorithm 808 may apply a battery of detectors comprising error-level analysis, JPEG block boundary analysis, resampling and affine-transform residue checks, color-filter-array (CFA) interpolation consistency tests, photo-response non-uniformity (PRNU) and splicing analysis, copy-move (pixel-duplication) detection, edge halo and lasso-cut boundary detection, lighting and shadow-field consistency estimation, font and glyph coherence scoring, and/or synthetic-content classifiers for AI-generated text and graphics, according to one embodiment.

The manipulation detection algorithm 808 may correlate EXIF timestamps, GPS, device model, and network provenance with web page capture times, order receipts, and commerce signals stored in the trusted authority database 132 to evaluate contextual credibility. The manipulation detection algorithm 808 may output an authenticity score, localized heatmaps highlighting suspected tampering regions, and categorized findings with labels such as “layering,” “lassoing,” “pixel duplication,” and “AI-generated overlay.” The manipulation detection algorithm 808 may forward feature maps to the machine learning subsystem 804 for ensemble scoring, pass authenticity assessments to the intent inference model 810 for alignment with the textual description 702, and publish structured results to the backend examination engine 706 and automatic classification output 812. The manipulation detection algorithm 808 may trigger the optional escalation module 714 for human review when suspicion exceeds configured thresholds, provide rationale snippets to the outcome generation engine 712 for refusal explanations, log artifacts in memory 114 for auditability, and emit progress events to the timeframe 508, according to one embodiment.

The intent inference model 810 may be a context-alignment subsystem hosted within the linguistic analysis server 110 and orchestrated through the linguistic API 108 to evaluate whether submitted specimen evidence and asserted goods and services reflect bona-fide use in commerce for a proposed trademark. The intent inference model 810 may derive a probabilistic “intent alignment” assessment by correlating visual, textual, and/or metadata signals with claimed identifications, thereby supporting authentication, fraud screening, and/or downstream legal analysis, according to one embodiment.

The intent inference model 810 may ingest feature bundles from the image processing engine 806 (cropped mark regions, scene descriptors, EXIF metadata), tamper signals from the manipulation detection algorithm 808 (heatmaps, alteration labels, authenticity score), and/or semantic features derived from the textual description 702 using the NLP model 716, together with class selections produced by the classification engine 704 and reference exemplars retrieved from the categorization database 134 and the trusted authority database 132. The intent inference model 810 may compute commerce-context features comprising storefront/page-layout patterns, packaging and label proximity, call-to-action cues, price and SKU presence, and timestamp consistency, according to one embodiment.

The intent inference model 810 may evaluate semantic alignment between asserted goods and services and detected objects and/or logos in specimen imagery. The intent inference model 810 may compare asserted first-use and/or marketing claims against crawled web page snapshots and registry timelines. The intent inference model 810 may output an intent-alignment score, categorical flags (e.g., “authentic merchandising,” “promotional only,” “mismatched goods,” “insufficient nexus”), and/or rationale snippets mapping contributing signals to conclusions. The intent inference model 810 may publish structured results to the backend examination engine 706 for fusion with similarity findings, forward alignment evidence to the legal reasoning module 710 for DuPont-factor weighting and disclaimer analysis, and supply disposition hints to the outcome generation engine 712 for automated approval and/or refusal narratives, according to one embodiment.

The automatic classification output 812 may be a decision and routing subsystem within the computer vision 802 and machine learning subsystem 804, hosted on the linguistic analysis server 110 and orchestrated through the linguistic API 108, configured to convert specimen-authentication analytics into actionable workflow outcomes for trademark evaluation, according to one embodiment.

The automatic classification output 812 may synthesize features from the image processing engine 806, alteration signals from the manipulation detection algorithm 808, and alignment scores from the intent inference model 810 with semantic context from the textual description 702 and predicted classes from the classification engine 704, producing a categorical disposition and/or an accompanying rationale. The automatic classification output 812 may receive normalized feature vectors, authenticity scores, intent-alignment scores, and DuPont-factor-relevant cues. The automatic classification output 812 may apply calibrated thresholds and rules derived from the set of comparative rules 138 and historical outcomes stored in the memory 114, according to one embodiment.

The automatic classification output 812 may generate a plurality of dispositions including “cleared for continued processing,” “suspicious-flag for review,” and/or “automated rejection with explanation”. The automatic classification output 812 may attach a structured explanation identifying contributing evidence (e.g., detected duplication patterns, layer artifacts, OCR text mismatch, and/or goods and services nexus gaps), according to one embodiment.

The automatic classification output 812 may persist the disposition and feature attributions to the memory 114 for audit logging, and may publish a routing directive to the backend examination engine 706 for similarity checks when cleared, to the optional escalation module 714 for human review when suspicious, and/or to the outcome generation engine 712 for immediate refusal drafting when rejection criteria met. The automatic classification output 812 may also transmit status and confidence metrics to the timeframe indicator 508 for user feedback, supply feature-importance summaries to the legal reasoning module 710 for incorporation into IRAC format rationale, and enqueue feature and outcome pairs for active-learning updates to the NLP model 716 and the design recognition algorithm 708, according to one embodiment.

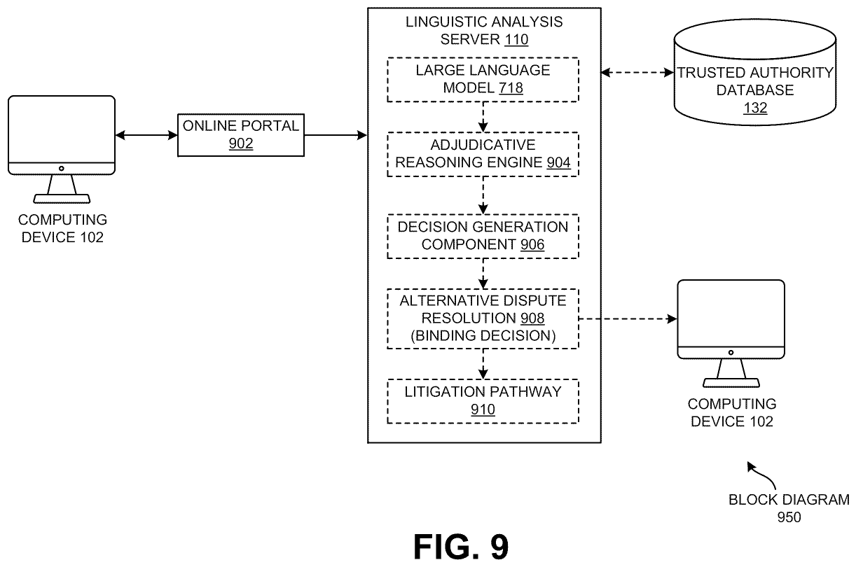

FIG. 9 is a block diagram 950 of the linguistic analysis server of FIG. 1 illustrating automated trademark conflict resolution system with an online dispute portal 902, according to one embodiment. FIG. 9 illustrates an online dispute portal 902, an adjudicative reasoning engine 904, a decision generation component 906, an alternative dispute resolution module 908, and a litigation pathway 910, according to one embodiment.

The online portal 902 may be a user-facing intake gateway within the computer implemented platform configured to collect, normalize, and transmit trademark dispute filings and supporting materials. The online portal 902 may render structured forms and/or a chat-guided workflow to capture party identities, proposed trademarks comprising a word mark, logo, and/or slogan, textual descriptions of goods and/or services, declarations, allegations, defenses, and proof-of-use artifacts sourced from photographs, packaging screenshots, and/or web pages, according to one embodiment.

The online portal 902 may perform account authentication, role authorization, field validation, file type checks, metadata extraction, timestamping, and case-ID assignment, then assemble a standards-based payload containing structured text, embedded media references, and consent flags for alternative dispute resolution. The online portal 902 may transmit the payload to the linguistic analysis server 110 via the linguistic API 108, request precedent and registry lookups from the trusted authority database 132, subscribe to progress and decision events from the adjudicative reasoning engine 904 and the decision generation component 906, and deliver binding-decision acknowledgments and/or litigation-referral packets produced by the alternative dispute resolution module 908 and the litigation pathway 910 back to a computing device 102, while persisting audit logs in memory 114, according to one embodiment.

The adjudicative reasoning engine 904 may be an AI-driven legal inference subsystem hosted within the linguistic analysis server 110 and orchestrated through the linguistic API 108 to convert evidentiary inputs into trademark adjudications. The adjudicative reasoning engine 904 may ingest a dispute payload received from the online portal 902 together with search findings and exemplar records retrieved from the trusted authority database 132 and feature summaries produced by upstream analysis components (e.g., classification suggestions, semantic/visual similarity findings), according to one embodiment.

The adjudicative reasoning engine 904 may employ the large language model 718 with domain prompts, the set of comparative rules 138, and a structured DuPont-factor schema to evaluate the likelihood of confusion, prior-use assertions, class overlap, dilution risk, and/or disclaimer requirements. The adjudicative reasoning engine 904 may run an internal adversarial process in which multiple role agents emulate perspectives of an examiner, an applicant, and an opposing party, then reconcile arguments into factor-by-factor scores and written findings of fact and law, according to one embodiment.

The adjudicative reasoning engine 904 may assemble the rationale object in IRAC format containing precedent citations, evidentiary references, proposed amendments, and recommended disposition type (binding decision, advisory decision, and/or escalation). The adjudicative reasoning engine 904 may transmit the rationale object to the decision generation component 906 for formatting and issuance, publish progress signals to the online portal 902 for user feedback, and route cases meeting escalation criteria to the alternative dispute resolution module 908 and the litigation pathway 910 while persisting analysis artifacts in memory 114 for audit logging, according to one embodiment.

The decision generation component 906 may be a server-side issuance subsystem within the linguistic analysis server 110, orchestrated through the linguistic API 108, configured to convert adjudicative analyses into formal outputs for the parties. The decision generation component 906 may ingest the rationale object from the adjudicative reasoning engine 904 including DuPont-factor scores, cited authorities from the trusted authority database 132, proposed amendments, and a recommended disposition and apply formatting, verification, and/or threshold checks derived from the set of comparative rules 138, according to one embodiment.

The decision generation component 906 may select an outcome type including a binding decision, an advisory decision, and/or a referral, then compose written findings of fact, legal reasoning, and a clear determination on the likelihood of confusion and infringement. The decision generation component 906 may generate structured artifacts including a signed decision notice, the IRAC style explanation, amendment instructions, and/or time-stamped audit metadata.

The decision generation component 906 may persist artifacts in memory 114, and dispatch user-readable payloads to the online portal 902 for delivery to computing device 102. The decision generation component 906 may route binding outcomes to the alternative dispute resolution 908 module, forward contested and/or non-binding outcomes toward the litigation pathway 910, and publish progress and status signals for downstream tracking and appeal scheduling, according to one embodiment.

The alternative dispute resolution module 908 may be a server-side adjudication subsystem within the linguistic analysis server 110, orchestrated through the linguistic API 108, configured to resolve trademark conflicts outside formal litigation. The alternative dispute resolution module 908 may accept a disposition package from the decision generation component 906 to include party submissions from the online portal 902, DuPont-factor findings from the adjudicative reasoning engine 904, and cited authorities retrieved from the trusted authority database 132, according to one embodiment.

The alternative dispute resolution module 908 may provide workflow states for negotiation, mediation, and/or arbitration. The alternative dispute resolution module 908 may manage consent to binding and/or advisory resolution. The alternative dispute resolution module 908 may enforce timing rules and evidentiary limits. The alternative dispute resolution module 908 may present structured proposals to parties via the online portal 902, collect counteroffers and concessions, invoke the large language model 718 to draft neutral term sheets, and upon agreement issue a binding decision with signatures, timestamps, and/or compliance milestones, according to one embodiment.

The alternative dispute resolution module 908 may persist artifacts in memory 114 for audit, publish outcome and compliance status to the online portal 902, and hand off unresolved and/or non-consenting matters to the litigation pathway 910 for court-track processing, according to one embodiment.

The litigation pathway 910 may be a server-side escalation subsystem within the linguistic analysis server 110, orchestrated through the linguistic API 108, configured to manage court track processing when parties decline settlement and/or when statutory triggers require judicial review. The litigation pathway 910 may transform adjudicative outputs into litigation-ready artifacts, maintain procedural timelines, and expose status updates to parties via the online portal 902, according to one embodiment.

The litigation pathway 910 may accept a referral package from the decision generation component 906 and/or the alternative dispute resolution module 908 containing submissions gathered by the online portal 902, DuPont-factor findings from the adjudicative reasoning engine 904, rationale from the legal reasoning module 710, and evidentiary references retrieved from the trusted authority database 132 and the categorization database 134, according to one embodiment.

The litigation pathway 910 may assemble pleadings templates, proposed findings, and exhibit lists by merging IRAC sections produced by the legal reasoning module 710 with conflict evidence scored by the backend examination engine 706 and visual descriptors produced by the design recognition algorithm 708. The litigation pathway 910 may apply the set of comparative rules 138 to map facts and authorities to jurisdiction-specific pleading sections, assign procedural deadlines, and/or generate a filing checklist, according to one embodiment.

The litigation pathway 910 may publish docket milestones and next-action prompts to the online portal 902, provide machine-readable status objects to the outcome generation engine 712, and route examiner and/or counsel feedback to the optional escalation module 714 when human intervention may be authorized. The litigation pathway 910 may persist pleadings drafts, exhibits, timestamps, and/or audit fields in the memory 114 for traceability, execute orchestration on the processor 112, and exchange notifications over the network 105 to maintain a complete, court-ready record, according to one embodiment.

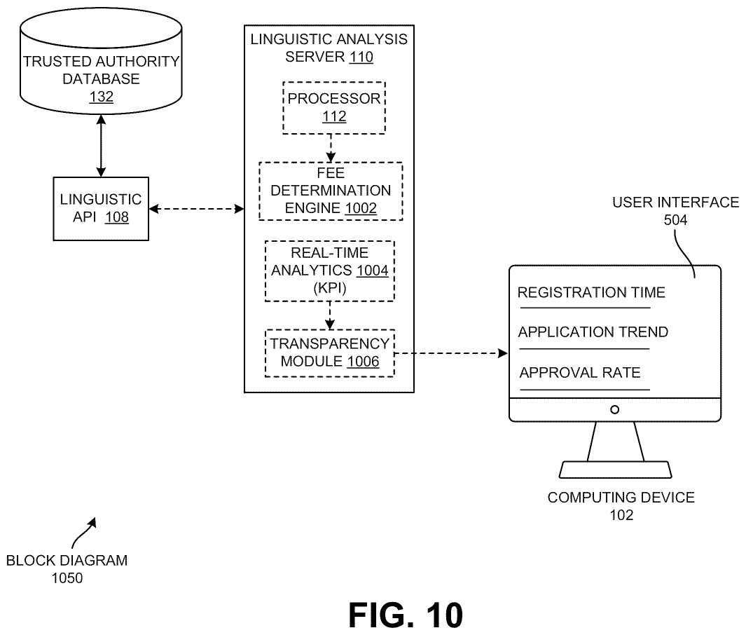

FIG. 10 is a block diagram 1050 of the linguistic analysis server 110 of FIG. 1 illustrating a fee determination engine 1002, a real-time analytics 1004 and a transparency module 1006 to calculate filing fees and to publish key performance indicators with processing time, approval and refusal rates, according to one embodiment. FIG. 10 illustrates a fee determination engine 1002, a real-time analytics 1004, and a transparency module 1006, according to one embodiment.

The fee determination engine 1002 may be a server side pricing subsystem within the linguistic analysis server 110 configured to compute a reduced and/or optimized filing fee for a trademark application. The fee determination engine 1002 may receive a structured payload from the user interface 504 including class count, mark type (word mark, logo, and/or slogan), goods and services breadth, the applicant 502 profile, and a declared system automation level, according to one embodiment.

The fee determination engine 1002 may retrieve baseline schedules, historical surcharges and discounts, and/or fairness guardrails from the trusted authority database 132 via the linguistic API 108, then apply rule-based and/or learned models to weight automation level, filing simplicity, and/or applicant profile to generate a fee quotation with confidence and rationale snippets. The fee determination engine 1002 may normalize currencies, apply class bundling where applicable, simulate scenarios for alternative class selections, and detect eligibility for low-income and/or small-entity reductions, according to one embodiment.

The fee determination engine 1002 may publish the quotation to the user interface 504 for applicant confirmation, emit metric events to the real-time analytics 1004 for KPI aggregation, and/or expose summarized results to the transparency module 1006, according to one embodiment.

The real-time analytics 1004 may be a telemetry and KPI aggregation subsystem within the linguistic analysis server 110 configured to compute and stream performance metrics for trademark evaluation and fee operations. The real-time analytics 1004 may ingest event messages from the classification engine 704, the backend examination engine 706, the legal reasoning module 710, the outcome generation engine 712, and the fee determination engine 1002 via the linguistic API 108, according to one embodiment.

The real-time analytics 1004 may timestamp events, normalize identifiers, and apply streaming calculations to derive registration processing time, 60-second service-level adherence, approval and refusal rates, class distribution, regional applicant trend, escalation frequency, fee savings attributable to automation, and/or bias-audit indicators. The real-time analytics 1004 may persist time-series and rollups in the memory 114, enforce anonymization for applicant data, and/or maintain versioned metric definitions for auditable reproducibility. The real-time analytics 1004 may expose query endpoints to the user interface 504 for live charts, publish summarized indicators to the transparency module 1006 for public dashboard rendering, and generate threshold alerts for operational monitoring, according to one embodiment.

The transparency module 1006 may be a web-facing publishing subsystem of the linguistic analysis server 110 configured to render a publicly accessible dashboard of performance metrics for trademark evaluation and registration. The transparency module 1006 may consume normalized KPI streams from the real-time analytics 1004 and curated reference counts from the trusted authority database 132 via the linguistic API 108, according to one embodiment.

The transparency module 1006 may assemble read only views showing registration processing time, approval and refusal rates, regional applicant trend, escalation frequency, fee savings attributable to automation from the fee determination engine 1002, and bias-audit indicators derived from outputs of the classification engine 704, the backend examination engine 706, the legal reasoning module 710, and the outcome generation engine 712. The transparency module 1006 may enforce privacy and governance by anonymizing applicant identifiers, redacting sensitive fields, and/or signing published datasets for provenance. The transparency module 1006 may cache time window rollups in the memory 114, expose query endpoints for the user interface 504 to draw live charts and tables, generate periodic snapshot reports for archival review, and/or surface threshold notices when KPIs deviate from service-level objectives, according to one embodiment.

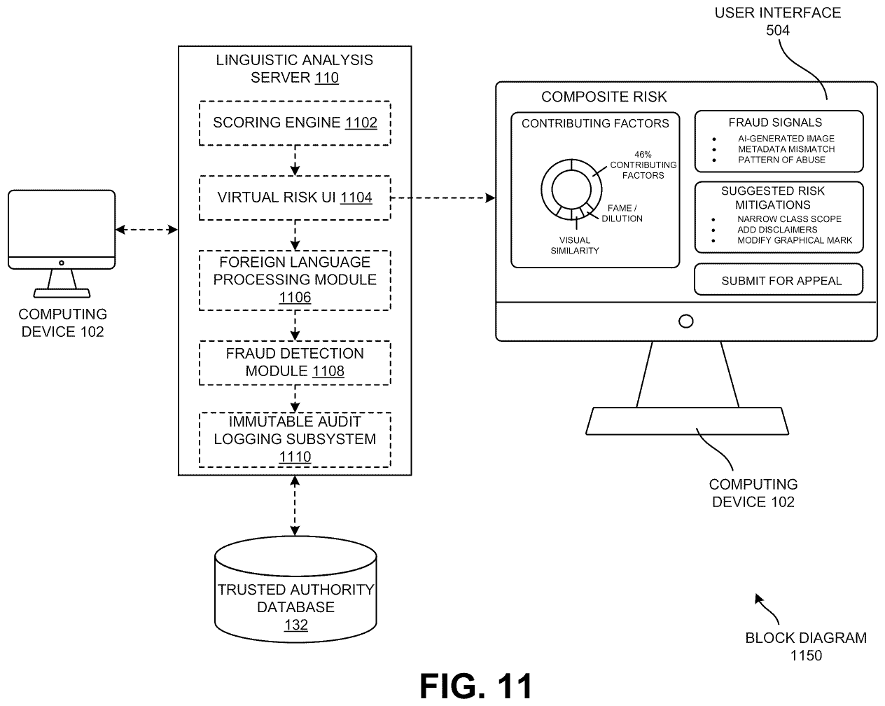

FIG. 11 is a block diagram 1150 of the linguistic analysis server 110 of FIG. 1 illustrating a scoring engine 1102 and a virtual risk UI 1104 to display contributing factors and suggestions via the user interface 504, according to one embodiment. FIG. 11 illustrates a scoring engine 1102, a virtual risk UI 1104, a foreign language processing module 1106, a fraud detection 1108, and an immutable audit logging subsystem 1110, according to one embodiment.

The scoring engine 1102 may be a server-side computation component within the linguistic analysis server 110 configured to convert multi-modal examination evidence into a composite trademark-conflict risk. The scoring engine 1102 may ingest normalized features from the classification engine 704 (selected classes and identification scope), the backend examination engine 706, the design recognition algorithm 708 (visual-similarity descriptors and match scores), the NLP model 716, the phonetic assessment module 130, and the legal reasoning module 710, according to one embodiment.

The scoring engine 1102 may standardize feature scales, apply DuPont-factor weighting for overall commercial impression, goods and services overlap, trade-channel proximity, purchaser care, and/or fame, and then compute the composite risk value with per-factor contribution percentages and confidence bounds. The scoring engine 1102 may generate a structured risk object containing the composite score, cited references, explanatory rationales, mitigation hooks, and/or deliver the structured risk object to the virtual risk UI 1104 for visualization. The scoring engine 1102 may persist the structured risk object in the immutable audit logging subsystem 1110 for traceability, and expose programmatic outputs to the outcome generation engine 712 for consistency across decision pathways, according to one embodiment.

The virtual risk UI 1104 may be a client-facing visualization layer within the linguistic analysis server 110 configured to present a composite trademark conflict risk on the user interface 504 of the computing device 102. The virtual risk UI 1104 may receive a structured risk object from the scoring engine 1102 containing the composite score, per-factor contributions based on DuPont weighting, cited references, and/or confidence bounds. The virtual risk UI 1104 may also subscribe to signals from the foreign language processing module 1106 and the fraud detection 1108 to surface transliteration matches and suspected abuse indicators, according to one embodiment.

The virtual risk UI 1104 may render a graphical dial and/or donut for the composite score, a contributing-factors panel to breaks out visual similarity, goods and services overlap, trade-channel proximity, purchaser care, fame and dilution, and phonetic semantic similarity, and/or a guidance panel labeled “Suggested Risk Mitigations” with actions including but not limited to class narrowing, disclaimer addition, and/or mark modification, according to one embodiment.

The virtual risk UI 1104 may expose interactive controls including a “Submit for Appeal” action button to package the structured risk object with the applicant 502 comments and forwards the package to the outcome generation engine 712 and/or the optional escalation module 714 for review, while persisting displayed values and user selections in the immutable audit logging subsystem 1110 for traceability. The virtual risk UI 1104 may update views in near real time when the scoring engine 1102 refreshes contributing evidence, and may standardize terminology with the categorization database 134 and the trusted authority database 132 to maintain consistency across filings, according to one embodiment.

The foreign language processing module 1106 may be a cross-lingual analysis subsystem within the linguistic analysis server 110 configured to interpret trademarks and goods and services descriptions written in non-English languages and/or scripts. The foreign language processing module 1106 may determine transliterated and translated equivalents to cause confusion and may generate cross-language evidence for downstream scoring and adjudication, according to one embodiment.

The foreign language processing module 1106 may ingest mark strings from the user interface 504, the textual description 702, OCR text extracted by the design recognition algorithm 708 from specimen imagery, and/or reference strings retrieved from the trusted authority database 132. The foreign language processing module 1106 may perform language and script identification, Unicode normalization, tokenization, morphological segmentation, and/or named-entity extraction. The foreign language processing module 1106 may create transliterations using standard tables (e.g., ISO-9 for Cyrillic, Revised Hepburn for Japanese, Hanyu Pinyin for Chinese), may compute phonetic keys and IPA approximations, and/or may expand homophones and near-homophones, according to one embodiment.

The foreign language processing module 1106 may generate machine translations and dictionary-based glosses, may embed original strings, transliterations, and translations in a multilingual vector space using the NLP model 716 and the large language model 718, and may compute semantic and phonetic proximity to registered, pending, and/or common-law references stored in the trusted authority database 132. The foreign language processing module 1106 may return a cross-lingual candidate list with similarity scores, aligned goods and services indications from the categorization database 134, and confidence bounds, according to one embodiment.

The foreign language processing module 1106 may forward scored candidates and rationales to the backend examination engine 706 for consolidation with same-language searches, to the scoring engine 1102 for composite risk computation, and to the legal reasoning module 710 for DuPont-factor evaluation involving translation and transliteration evidence. The foreign language processing module 1106 may surface “transliteration match” and/or “translation equivalent” signals to the virtual risk UI 1104 for applicant visibility, may persist features and outcomes in the immutable audit logging subsystem 1110 for traceability, and may route ambiguous language cases to the optional escalation module 714 for human review, according to one embodiment.

The fraud detection module 1108 may be a risk-analytics subsystem hosted within the linguistic analysis server 110 and orchestrated through the linguistic API 108. The fraud detection 1108 may be configured to identify indicators of bad faith filing behavior and specimen forgery and may generate machine readable alerts for downstream review and decision synthesis.

The fraud detection module 1108 may ingest a normalized dossier from the classification engine 704 and the backend examination engine 706 together with specimen features from the image processing engine 806 and the manipulation detection algorithm 808, textual features derived by the NLP model 716, and account, device, and session metadata collected through the user interface 504 on the computing device 102, according to one embodiment.

Historical filings and cross-account linkages may be retrieved from the trusted authority database 132 and the categorization database 134. Feature engineering may include EXIF and timestamp checks, geolocation plausibility checks, near-duplicate image hashing, GAN and AI-content fingerprints, compression and resampling artifacts, template reuse detection, stylometry and boilerplate phrase detection, velocity of submissions across accounts, IP and device fingerprint reuse, and/or conflicts among claimed first-use dates and marketplace evidence, according to one embodiment.

The fraud detection module 1108 may apply supervised and unsupervised models provided by the machine learning subsystem 804, may evaluate graph-based relationships among applicants and marks. The fraud detection module 1108 may request reasoning assistance from the large language model 718 for rule interpretation and anomaly explanation. A calibrated rule layer may combine model outputs to produce a fraud-risk score, a list of triggered signals, and/or human-readable rationales, according to one embodiment.

The fraud detection module 1108 1108 may forward risk scores and explanations to the scoring engine 1102 for inclusion in the composite risk value, may render a “Fraud Signals” panel on the virtual risk UI 1104, and may supply recommended actions to the outcome generation engine 712, including automatic rejection, conditional acceptance with proofs, and/or referral. High-risk dossiers may be routed to the optional escalation module 714 for human review. Events, features, and dispositions may be persisted in the immutable audit logging subsystem 1110 for regulatory traceability and performance auditing, according to one embodiment.

The immutable audit logging subsystem 1110 may be a compliance and traceability service hosted within the linguistic analysis server 110 and orchestrated through the linguistic API 108. The immutable audit logging subsystem 1110 may provide append only, tamper-evident recording of AI-assisted trademark evaluation activity to satisfy regulatory, evidentiary, and/or transparency requirements, according to one embodiment.

The immutable audit logging subsystem 1110 may capture time-stamped events and artifacts generated across the platform, including payloads received from the user interface 504 on the computing device 102, feature vectors and class suggestions produced by the classification engine 704, similarity findings compiled by the backend examination engine 706, visual descriptors emitted by the design recognition algorithm 708 and the computer vision 802, legal analyses produced by the legal reasoning module 710, decisions formatted by the outcome generation engine 712, escalation actions managed by the optional escalation module 714, language features produced by the NLP model 716, inference metadata from the large language model 718, risk indicators from the scoring engine 1102 and the fraud detection module 1108, outputs from the foreign language processing module 1106, and KPI snapshots forwarded to the real-time analytics 1004 and the transparency module 1006, according to one embodiment.

The immutable audit logging subsystem 1110 may define a canonical event schema covering case identifiers, model versions, configuration hashes, input fingerprints, intermediate scores, DuPont-factor rationales, user actions, reviewer annotations, and final outcomes. The immutable audit logging subsystem 1110 may compute cryptographic digests for each event, link digests in a hash-chain sequence, and/or apply trusted time-stamps to establish ordering, according to one embodiment.

The immutable audit logging subsystem 1110 may persist chained records in append-only storage within the memory 114 and/or write-once media, maintain redundant indices for retrieval by case, date, and module, and expose read-only retrieval through the linguistic API 108 with role-based access control, according to one embodiment.

The immutable audit logging subsystem 1110 may support privacy preserving operations by storing personally identifiable elements as salted tokens and by retaining reversible mappings under key-management policies enforced by the processor 112. The immutable audit logging subsystem 1110 may provide query and export functions for appeals, ADR, and litigation pathways. The immutable audit logging subsystem 1110 may generate verification receipts for the transparency module 1006, and/or may emit integrity alerts when hash-chain continuity fails, according to one embodiment.

The immutable audit logging subsystem 1110 may further record model-lifecycle events for the backend examination engine 706, the NLP model 716, and the large language model 718, including training datasets, evaluation metrics, and deployment approvals, thereby enabling end-to-end provenance for decisions presented on the approval page 510 and the refusal page 602, according to one embodiment.

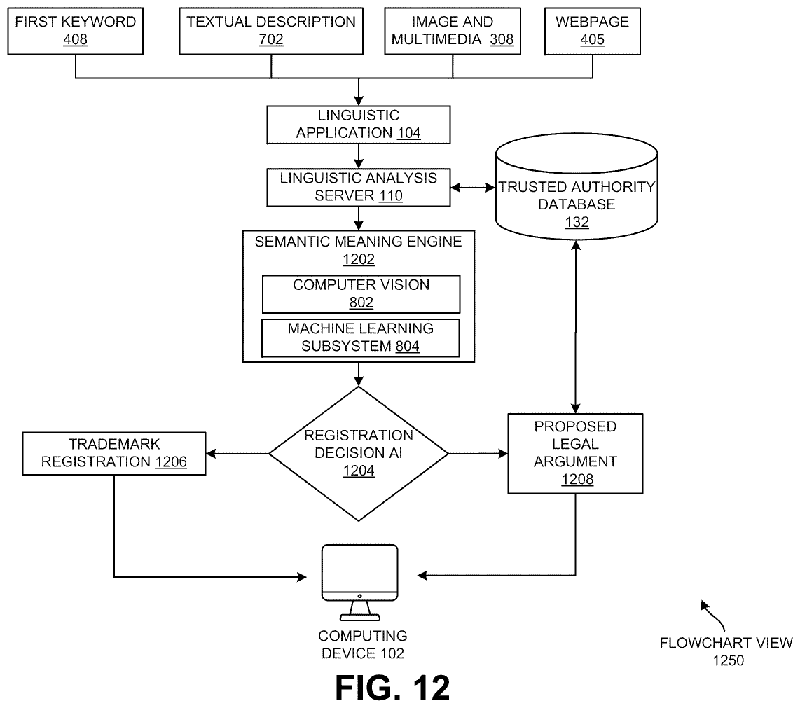

FIG. 12 is a flowchart view 1250 of the linguistic analysis server 110 of FIG. 1 illustrating a semantic meaning engine 1202 and registration decision process, according to one embodiment. FIG. 12 illustrates a semantic meaning engine 1202, a registration decision AI 1204, a trademark registration 1206, and a proposed legal argument 1208, according to one embodiment.

The semantic meaning engine 1202 may be a server-side reasoning subsystem within the linguistic analysis server 110 configured to associate the first keyword 408 with a semantic meaning derived from secondary evidence. The semantic meaning engine 1202 may unify textual, visual, and/or contextual signals to produce decision-ready features for downstream adjudication. The semantic meaning engine 1202 may ingest a structured payload from the linguistic application 104 including the first keyword 408, the textual description 702, the image and multimedia 308, and the web page 405, according to one embodiment.

The semantic meaning engine 1202 may perform language detection, tokenization, normalization, and/or embedding of the textual description 702 and page content using the NLP capabilities provided by the machine learning subsystem 804, while the computer vision 802 may extract mark regions, stylization descriptors, and/or optional OCR tokens from the image and multimedia 308. The semantic meaning engine 1202 may fuse textual embeddings and visual descriptors into a multimodal representation, retrieve candidate references from the trusted authority database 132, and compute similarity vectors across semantic, visual, and/or commercial-context dimensions, according to one embodiment.

The semantic meaning engine 1202 may weight evidence by DuPont-factor signals, detect class overlap using outputs from the classification workflow, and generate factorized findings with matched phrases, image correspondences, confidence scores, and/or provenance links. The semantic meaning engine 1202 may forward the feature set to the registration decision AI 1204 for disposition selection and to the legal reasoning module 710 for IRAC-style rationale construction, while persisting intermediate artifacts for audit and active-learning updates through the machine learning subsystem 804, according to one embodiment.

The registration decision AI 1204 may be a decision synthesis subsystem within the linguistic analysis server 110 configured to select a registrability disposition within a short predefined time window, according to one embodiment.

The registration decision AI 1204 may ingest a feature set from the semantic meaning engine 1202 including semantic embeddings, visual descriptors from the computer vision 802, classification context, goods and services mappings from the categorization process, and/or confidence scores produced by the machine learning subsystem 804. The registration decision AI 1204 may retrieve the set of comparative rules 138 and reference authorities from the trusted authority database 132, according to one embodiment.

The registration decision AI 1204 may compute a composite likelihood of confusion and dilution score, evaluate absolute-bar conditions, and/or apply disposition thresholds. When approval criteria satisfy configured bounds, the registration decision AI 1204 may assemble the trademark registration 1206 payload with class codes, specimen status, and registry handoff metadata for delivery to the computing device 102 through the user interface 504, according to one embodiment.

When refusal criteria prevail, the registration decision AI 1204 may trigger generation of the proposed argument 1208 by invoking legal-analysis routines, populate factor-by-factor reasoning and amendment suggestions, and/or transmit a refusal package to the user interface 504. The registration decision AI 1204 may publish progress signals, persist artifacts for immutable audit logging, and/or record features for active-learning refinement, according to one embodiment.

The trademark registration 1206 may be an approval artifact generated by the linguistic analysis server 110 to memorialize an automated grant of registrability for a proposed mark. The trademark registration 1206 may be a structured payload containing a registration number, owner identifiers, goods and services classifications, filing basis and proof-of-use status, specimen references, effective dates, and/or links to reasoning and audit records, according to one embodiment.

The trademark registration 1206 may be produced when the registration decision AI 1204 evaluates features received from the semantic meaning engine 1202, applies the set of comparative rules 138 and authority references from the trusted authority database 132, and/or determine approval thresholds may be satisfied. The trademark registration 1206 may then trigger a registry handoff to the trusted authority database 132 for number assignment and record creation, persist metadata in the memory 114 for immutable audit logging, and transmit a machine-readable and human-readable confirmation to the computing device 102 via the user interface 504, enabling certificate rendering and downstream lifecycle actions comprising maintenance reminders and/or analytics ingestion, according to one embodiment.

The proposed legal argument 1208 may be a machine-generated legal memorandum formatted in issue, rule, application, and conclusion (IRAC) to document adjudicative reasoning for a proposed trademark. The proposed legal argument 1208 may be an editable rationale supporting a preliminary approval, supporting a preliminary refusal, and/or supporting amendment suggestions for reconsideration and appeal, according to one embodiment.

The proposed legal argument 1208 may be assembled from feature outputs produced by the semantic meaning engine 1202, classification suggestions from the classification engine 704, similarity and conflict findings from the backend examination engine 706 including visual features from the design recognition algorithm 708, and authority references retrieved from the trusted authority database 132 using the set of comparative rules 138. The proposed legal argument 1208 may declare a plurality of issues framed under Lanham Act § 2 and/or DuPont-factor considerations, cite controlling and persuasive rules with pinpoint references, apply facts derived from the first keyword 408, the textual description 702, the image and multimedia 308, and the web page 405 to each factor, and state a conclusion indicating registrability, likelihood of confusion, dilution, and/or disclaimer requirements, according to one embodiment.

The proposed legal argument 1208 may include proposed amendments comprising class narrowing and disclaimer language, cross-references to conflicting registrations and pending applications, confidence measures, and generation timestamps. The proposed legal argument 1208 may be emitted in human-readable and machine-readable forms, persisted in the memory 114 for immutable audit logging, delivered to the user interface 504 for review, and forwarded to the optional escalation module 714 when human examination may be requested, according to one embodiment.

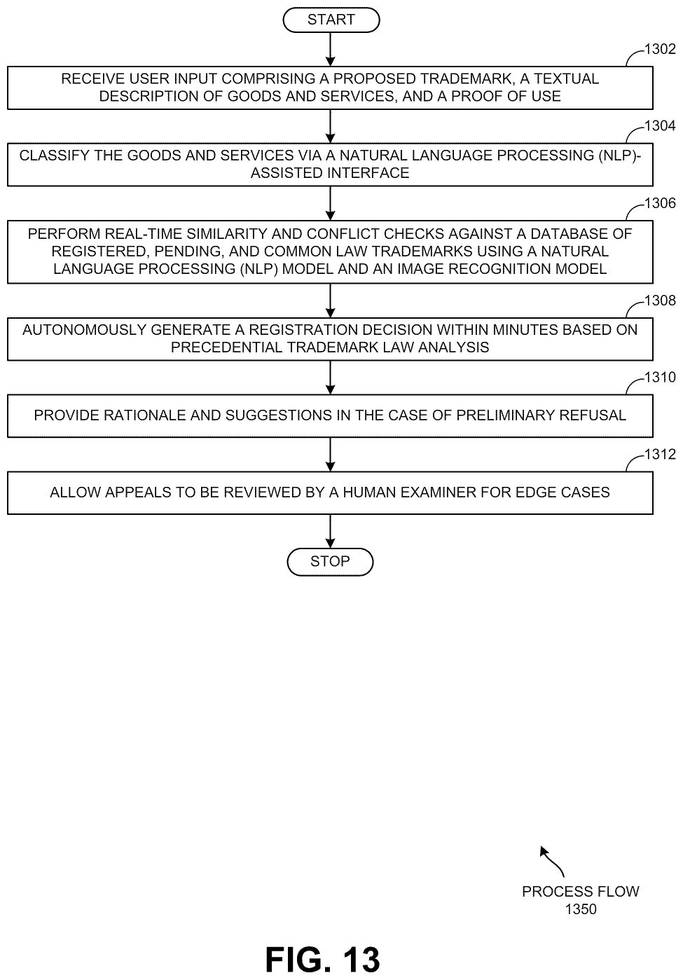

FIG. 13 is a process flow diagram 1350 of the linguistic analysis server 110 of FIG. 1 illustrating a multilingual foreign-language processing model to analyze trademarks in all human languages, according to one embodiment.

In operation 1302, a computer-implemented platform for automating evaluation and registration of a trademark of the linguistic analysis server 110 may receive a user input comprising a proposed trademark, a textual description of goods and services, and a proof of use. In operation 1304, a classification engine 702 of the linguistic analysis server 110 may classify the goods and services via a natural language processing (NLP) assisted interface, according to one embodiment.

In operation 1306, a backend examination engine 708 and a legal reasoning module 712 of the linguistic analysis server 110 may perform real-time similarity and conflict checks against a database of registered, pending, and common law trademarks using a natural language processing (NLP) model and an image recognition model. In operation 1308, an outcome generation engine of the linguistic analysis server 110 may autonomously generate a registration decision within minutes based on precedential trademark law analysis, according to one embodiment.

In operation 1310, the legal reasoning module 712 of the linguistic analysis server 110 may provide rationale and suggestions in the case of preliminary refusal. In operation 1312, an optional escalation module 716 of the linguistic analysis server 110 may allow appeals to be reviewed by a human examiner for edge cases, according to one embodiment.

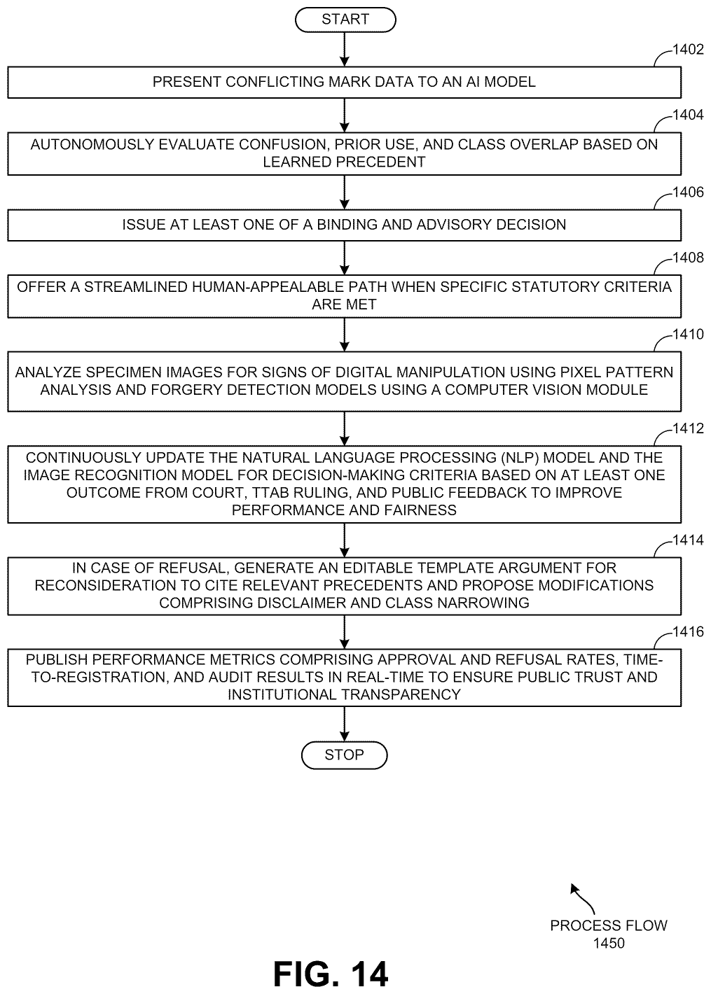

FIG. 14 is a process flow diagram 1450 of the linguistic analysis server 110 of FIG. 1 illustrating a fraud detection module to analyze patterns of repeated submissions, according to one embodiment.

In operation 1402, the adjudicative reasoning engine 904 of the linguistic analysis server 110 may present conflicting mark data to an AI model. In operation 1404, the adjudicative reasoning engine 904 may autonomously evaluate confusion, prior use, and/or class overlap based on learned precedent. In operation 1406, the outcome generation engine 712 of the linguistic analysis server 110 may issue a binding and/or advisory decision, according to one embodiment.

In operation 1408, the adjudicative reasoning engine 904 of the linguistic analysis server 110 may offer a streamlined human-appealable path when specific statutory criteria may be met. In operation 1410, a computer vision module 802 may analyze specimen images for signs of digital manipulation using pixel pattern analysis and forgery detection models, according to one embodiment.

In operation 1412, the natural language processing (NLP) model 716 and the image recognition model 708 may continuously update the decision-making criteria based on outcome from court, TTAB ruling, and public feedback to improve performance and fairness, according to one embodiment.

In operation 1414, in case of refusal, the linguistic analysis server 110 may generate an editable template argument for reconsideration to cite relevant precedents and propose modifications including disclaimer and class narrowing. In operation 1416, the linguistic analysis server 110 may publish performance metrics including approval and refusal rates, time-to-registration, and audit results in real-time to ensure public trust and institutional transparency, according to one embodiment.

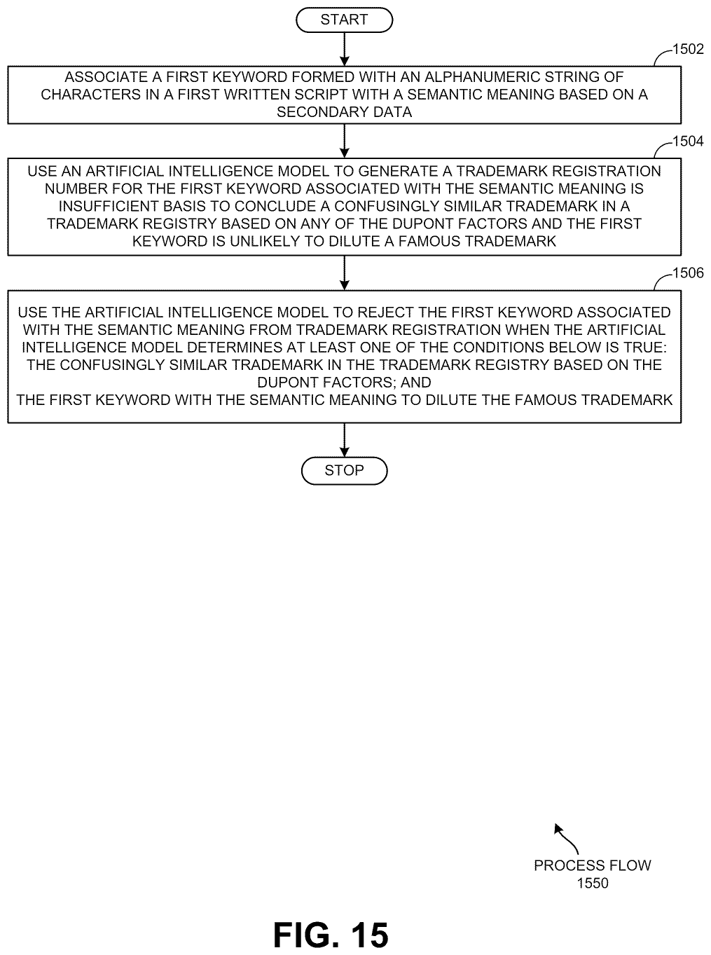

FIG. 15 is a process flow diagram 1550 of the linguistic analysis server 110 of FIG. 1 illustrating an immutable audit logging subsystem 1110 in trademark evaluation processes, according to one embodiment.

In operation 1502, the platform of the linguistic analysis server 110 may associate a first keyword 408 formed with an alphanumeric string of characters 410 in a first written script 404 with a semantic meaning based on secondary data.

In operation 1504, using an artificial intelligence model, the platform of the linguistic analysis server 110 may generate a trademark registration number for the first keyword 408 associated with the semantic meaning may be insufficient basis to conclude a confusingly similar trademark in a trademark registry based on any of the DuPont factors and the first keyword 408 may be unlikely to dilute a famous trademark.

In operation 1506, using the artificial intelligence model, the platform of the linguistic analysis server 110 may reject the first keyword 408 associated with the semantic meaning from the trademark registration 1206 when the artificial intelligence model determines the condition below to be true: the confusingly similar trademark in the trademark registry based on the DuPont factors, and/or a likelihood for the first keyword 408 with the semantic meaning to dilute a famous trademark, according to one embodiment.

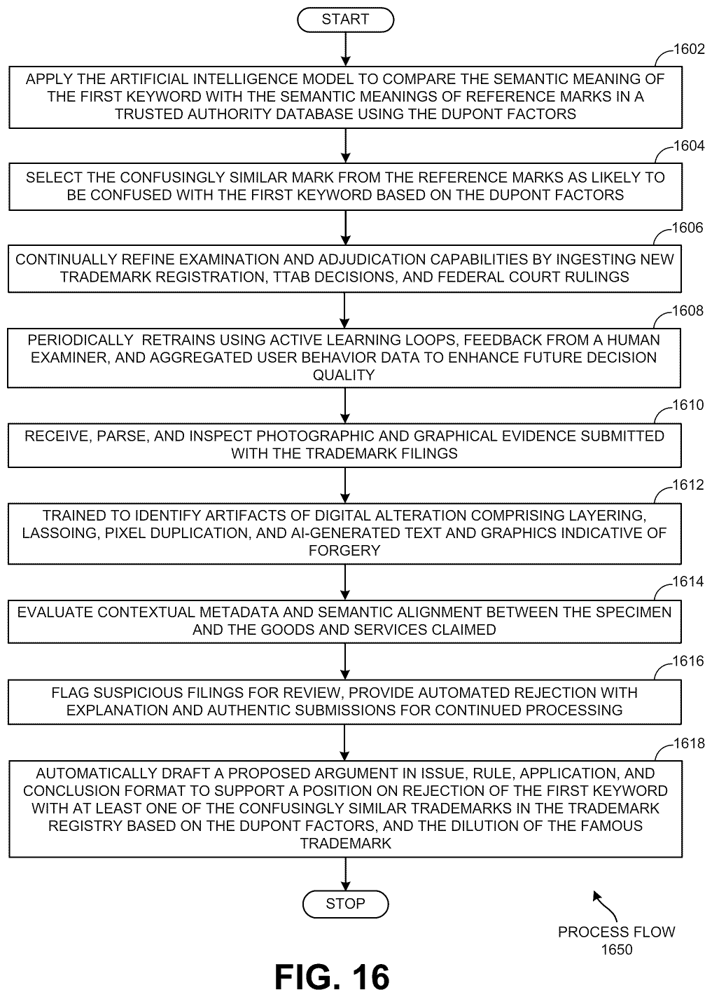

FIG. 16 is a process flow diagram 1650 of the linguistic analysis server 110 of FIG. 1 illustrating a continuous model refinement loop to enhance decision quality over time, according to one embodiment.

In operation 1602, the platform may apply the artificial intelligence model to compare the semantic meaning of the first keyword 408 with the semantic meanings of reference marks in a trusted authority database 132 using the DuPont factors. In operation 1604, the platform may select a confusingly similar mark from the reference marks as likely to be confused with the first keyword 408 based on the DuPont factors, according to one embodiment.

In operation 1606, the backend examination engine 706 may continually refine examination and adjudication capabilities by ingesting new trademark registrations, TTAB decisions, and federal court rulings. In operation 1608, the backend examination engine 706 and supporting models may periodically retrain using active learning loops, feedback from a human examiner, and/or aggregated user behavior data to enhance future decision quality, according to one embodiment.

In operation 1610, the computer vision 802 and machine learning subsystem 804 may receive, parse, and/or inspect photographic and graphical evidence submitted with trademark filings. In operation 1612, a manipulation detection algorithm 808 may be trained to identify artifacts of digital alteration including layering, lassoing, pixel duplication, AI-generated text and/or graphics indicative of forgery, according to one embodiment.

In operation 1614, an intent inference model 810 may evaluate contextual metadata and semantic alignment between each specimen and the goods and services claimed. In operation 1616, an automated classification output 812 may flag suspicious filings for review, provide automated rejection with explanation, and clear authentic submissions for continued processing, according to one embodiment.

In operation 1618, the platform may automatically draft a proposed legal argument 1208 in issue, rule, application, and conclusion format to support a position on rejection of the first keyword 408 with confusingly similar trademark in the trademark registry based on the DuPont factors and dilution of the famous trademarks, according to one embodiment.

Although the present embodiments have been described with reference to specific example embodiments, it will be evident that various modifications and changes may be made to these embodiments without departing from the broader spirit and scope of the various embodiments.

A number of embodiments have been described. Nevertheless, it will be understood that various modifications may be made without departing from the spirit and scope of the claimed invention. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

It may be appreciated that the various systems, methods, and apparatus disclosed herein may be embodied in a machine-readable medium and/or a machine accessible medium compatible with a data processing system (e.g., a computer system), and/or may be performed in any order.

The structures and modules in the figures may be shown as distinct and communicating with only a few specific structures and not others. The structures may be merged with each other, may perform overlapping functions, and may communicate with other structures not shown to be connected in the figures. Accordingly, the specification and/or drawings may be regarded in an illustrative rather than a restrictive sense.

1. A computer-implemented platform for automating evaluation and registration of a trademark, the platform comprising:
a user-facing interface to enable an applicant to input a proposed trademark comprising at least one of a word mark, logo, and slogan along with a textual description of associated goods and services, and optionally, visual proof of use in commerce;
a classification engine powered by a natural language processing (NLP) model to dynamically assist the applicant in selecting appropriate classes of goods and services from standardized taxonomies;
a backend examination engine to perform real-time searches and comparative analyses across databases of registered, pending, and common law marks using a large language model and a design recognition algorithm;
an autonomous legal reasoning module powered by the large language model (LLM) configured to interpret trademark law precedents, disclaimer requirements, and registration criteria, and to simulate multi-perspective legal analysis through an internal adversarial process; and
an outcome generation engine to deliver, within a predefined time frame, at least one of a preliminary approval with automated registration and a preliminary refusal with detailed explanation and recommended amendments.

2. The computer-implemented platform for automating the evaluation and registration of the trademark of claim 1 further comprising:
an optional escalation module to enable a human review for applications exhibiting novel, ambiguous, and potentially contested legal characteristics.

3. The computer-implemented platform for automating the evaluation and registration of the trademark of claim 1 further comprising:
a computer vision and a machine learning subsystem for authenticating submitted trademark specimens, additionally comprising:
an image processing engine to receive, parse, and inspect photographic and graphical evidence submitted with trademark filing;
a manipulation detection algorithm trained to identify artifacts of digital alteration comprising at least one of layering, lassoing, pixel duplication, and AI-generated text and graphics indicative of forgery;
an intent inference model to evaluate contextual metadata and semantic alignment between the specimen and the goods and services claimed; and
an automated classification output to flag suspicious filings for review, provide automated rejection with explanation, and clear authentic submissions for continued processing.

4. The computer-implemented platform for automating the evaluation and registration of the trademark of claim 1 wherein:
upon preliminary refusal, the platform automatically generates a structured, editable response for reconsideration and appeal, citing legal justifications, alternative classifications, and recommended disclaimers to improve registrability likelihood.

5. The computer-implemented platform for automating the evaluation and registration of the trademark of claim 1 wherein the backend examination engine to:
continually refine examination and adjudication capabilities by ingesting new trademark registrations, TTAB decisions, and federal court rulings; and
periodically retrain using active learning loops, feedback from a human examiner, and an aggregated user behavior data to enhance future decision quality.

6. The computer-implemented platform for automating the evaluation and registration of the trademark of claim 1 further comprising:
a fee determination engine to reduce filing costs based on system automation level, applicant profile, and filing simplicity, thereby lowering the economic barrier to entry for entrepreneurs with lesser economic means; and
a real-time analytics and a transparency module to publish key performance indicators (KPIs), comprising registration processing time, approval and refusal rate, regional applicant trend, and bias audit in a dashboard,
wherein the dashboard is publicly accessible and designed to foster government accountability and public trust.

7. The computer-implemented platform for automating the evaluation and registration of the trademark of claim 1, the platform further comprising:
a fully automated dispute resolution system for trademark conflicts, further comprising:
an online portal wherein two or more parties upload potentially conflicting trademarks with claims of ownership, evidence of first use in commerce within the United States, allegations and defenses to trademark infringement, and declarations in support and opposition thereto,
an adjudicative reasoning engine to use pre-trained legal inference models to assess likelihood of confusion, prior use, and classification conflicts based on statutory law and judicial precedent,
a decision generation component to produce written findings of fact, legal reasoning, and determination on confusion and infringement is likely, and
optional pathways for a supplemental alternative dispute resolution and a litigation pathway in which one party is unsatisfied with the written findings.

8. The computer-implemented platform for automating the evaluation and registration of the trademark of claim 1, the platform further comprising:
a scoring engine to weight semantic and visual conflicts based on the DuPont factors and outputs a composite risk score; and
a user interface to visually display the composite risk score with contributing factors and suggestions to reduce risk.

9. The computer-implemented platform for automating the evaluation and registration of the trademark of claim 1, the platform further comprising:
a foreign language processing model trained in all human languages to analyze foreign-language trademarks and identify transliterated and translated similarities causing confusion;
a fraud detection module configured to analyze patterns of repeated submissions, altered specimens, and conflicting claims across user accounts to flag potential bad-faith filings; and
an immutable audit logging subsystem to store timestamped records of AI-generated decisions, user actions, and revision history to enable traceability and regulatory compliance.

10. A computer-implemented method to register a trademark, the method comprising:
receiving user input comprising a proposed trademark, a textual description of goods and services, and a proof of use;
classifying the goods and services via a natural language processing (NLP)-assisted interface;
performing real-time similarity and conflict checks against a database of registered, pending, and common law trademarks using a natural language processing (NLP) model and an image recognition model;
autonomously generating a registration decision within minutes based on precedential trademark law analysis;
providing rationale and suggestions in the case of preliminary refusal; and
allowing appeals to be reviewed by a human examiner for edge cases.

11. The computer-implemented method to register the trademark of claim 10, the method further comprising:
presenting conflicting mark data to an AI model;
autonomously evaluating confusion, prior use, and class overlap based on learned precedent;
issuing at least one of a binding and advisory decision; and
offering a streamlined human-appealable path when specific statutory criteria are met.

12. The computer-implemented method to register the trademark of claim 10, the method further comprising:
analyzing specimen images for signs of digital manipulation using pixel pattern analysis and forgery detection models using a computer vision module, configured to:
cross-reference time, metadata, and commerce signals to validate authenticity, and
flag potentially fraudulent filings for at least one manual review and automatic rejection.

13. The computer-implemented method to register the trademark of claim 10, the method further comprising:
continuously updating the natural language processing (NLP) model and the image recognition model for decision-making criteria based on at least one outcome from court, TTAB ruling, and public feedback to improve performance and fairness.

14. The computer-implemented method to register the trademark of claim 10, the method further comprising:
in case of refusal, generating an editable template argument for reconsideration to cite relevant precedents and propose modifications comprising disclaimer and class narrowing.

15. The computer-implemented method to register the trademark of claim 10, the method further comprising:
publishing performance metrics comprising approval and refusal rates, time-to-registration, and audit results in real-time to ensure public trust and institutional transparency.

16. A method of generating a trademark registration comprising:
associating a first keyword formed with an alphanumeric string of characters in a first written script with a semantic meaning based on a secondary data comprising at least one of:
an image allegedly of a photograph of the first keyword affixed on an article of manufacture of an applicant for the trademark registration, and a contextual credibility of the image as a true and correct representation of the photograph,
a textual description of goods and services on which the first keyword the applicant for the trademark registration represents as at least one of the goods and services on which the first keyword is at least one desired to be affixed, and
a web page that the applicant for the trademark registration represents as marketing at least one of the goods and services associated with the first keyword, and a contextual relevancy of the web page as actually marketing at least one of the goods and services;
using an artificial intelligence model to generate a trademark registration number for the first keyword associated with the semantic meaning is insufficient basis to conclude a confusingly similar trademark in a trademark registry based on any of the DuPont factors and the first keyword is unlikely to dilute a famous trademark;
using the artificial intelligence model to reject the first keyword associated with the semantic meaning from trademark registration when the artificial intelligence model determines at least one of the conditions below is true:
the confusingly similar trademark in the trademark registry based on the DuPont factors; and
the first keyword with the semantic meaning to dilute the famous trademark.

17. The method of claim 16 to generate the trademark registration:
wherein rejecting the first keyword associated with the semantic meaning from the trademark registration:
applying the artificial intelligence model to compare the semantic meaning of the first keyword with the semantic meanings of reference marks in a trusted authority database using the DuPont factors, and
selecting the confusingly similar mark from the reference marks as likely to be confused with the first keyword based on the DuPont factors.

18. The method of claim 16 to generate the trademark registration, wherein a backend examination engine to:
continually refine examination and adjudication capabilities by ingesting new trademark registrations, TTAB decisions, and federal court rulings; and
periodically retrains using active learning loops, feedback from a human examiner, and aggregated user behavior data to enhance future decision quality.

19. The method of claim 16 to generate the trademark registration, wherein a computer vision and a machine learning subsystem to authenticate submitted trademark specimens, using:
an image processing engine to receive, parse, and inspect photographic and graphical evidence submitted with trademark filings,
a manipulation detection algorithm trained to identify artifacts of digital alteration comprising layering, lassoing, pixel duplication, and AI-generated text and graphics indicative of forgery,
an intent inference model to evaluate contextual metadata and semantic alignment between the specimen and the goods and services claimed, and
an automated classification output to flag suspicious filings for review, provide automated rejection with explanation, and clear authentic submissions for continued processing.

20. The method of claim 16 to generate the trademark registration, further comprising:
automatically drafting a proposed legal argument in issue, rule, application, and conclusion format to support a position on rejection of the first keyword with at least one of the confusingly similar trademarks in the trademark registry based on the DuPont factors, and the dilution of the famous trademark.
